(19) United States
(12) Patent Application Publication
(10) Pub. No.: US 2023/0169425 A1
(43) Pub. Date: Jun. 1, 2023

(54) GAMIFICATION OF BUSINESS PROCESSES

(71) Applicant: Denver Search, LLC, Denver, CO (US)

(72) Inventors: Aditya Nagrath, Denver, CO (US); Max Roschke, Denver, CO (US)

(21) Appl. No.: 17/895,493

(22) Filed: Aug. 25, 2022

Related U.S. Application Data
(63) Continuation-in-part of application No. 17/707,328, filed on Mar. 29, 2022.
(60) Provisional application No. 63/236,867, filed on Aug. 25, 2021.
(60) Provisional application No. 63/167,378, filed on Mar. 29, 2021.

(51) Int. Cl. G06Q 10/0631; G06Q 10/1093

(52) U.S. Cl. CPC G06Q 10/063114; G06Q 10/1095

(57) ABSTRACT

Embodiments of the present disclosure are directed to managing business processes. As described herein, managing one or more business processes and/or projects can be done in a manner that gamifies the processes or project. That is, the employees of the business can be treated as a team and assigned points, either individually or to the team, as they complete tasks related to the project or operation of the business more generally. Not only does this approach assist with automating the management of the various projects and/or processes of operating the business, but it helps to keep the employees engaged, on task, and working together towards defined goals.

### CROSS REFERENCE TO RELATED APPLICATION

The present application claims the benefits of and priority, under 35 U.S.C. § 119(e), to U.S. Provisional Application No. 63/236,867 filed Aug. 25, 2021 by Nagrath et al and entitled “Gamification of Business Processes” of which the entire disclosure is incorporated herein by reference for all purposes.

The present application is also a continuation-in-part of and claims priority to U.S. patent application Ser. No. 17/707,328 filed Mar. 29, 2022 by Nagrath et al and entitled “Gamification of Business Processes” which in turn claims priority to U.S. Provisional Application No. 63/167,378 filed Mar. 29, 2021 by Nagrath et al and entitled “Gamification of Business Processes” of which the entire disclosure of each is incorporated herein by reference for all purposes.

### FIELD OF THE DISCLOSURE

Embodiments of the present disclosure relate generally to methods and systems for the automated management of business processes and more particularly to the automated management of business process, tasks, and communications in a manner that encourages productivity.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an exemplary environment for implementing gamification of business processes according to one embodiment of the present disclosure.

FIG. 4 is a flowchart illustrating an exemplary process for gamification of business processes according to one embodiment of the present disclosure.

FIG. 5 is a flowchart illustrating an exemplary process for managing scoring within gamification of business processes according to one embodiment of the present disclosure.

FIG. 6 is a flowchart illustrating an exemplary process for managing communications within gamification of business processes according to one embodiment of the present disclosure.

FIG. 7 is a flowchart illustrating an exemplary process for managing meetings within gamification of business processes according to one embodiment of the present disclosure.

FIGS. 8-38 are screenshots illustrating exemplary user interfaces for conducting meetings according to one embodiment of the present disclosure.

FIGS. 39-48 are screenshots illustrating exemplary user interfaces for conducting surveys according to one embodiment of the present disclosure.

FIGS. 49 and 50 are screenshots illustrating exemplary user interfaces for updating a To Do item during a meeting according to one embodiment of the present disclosure.

FIG. 51 is a flowchart illustrating an exemplary process for updating one or more tasks during a meeting according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

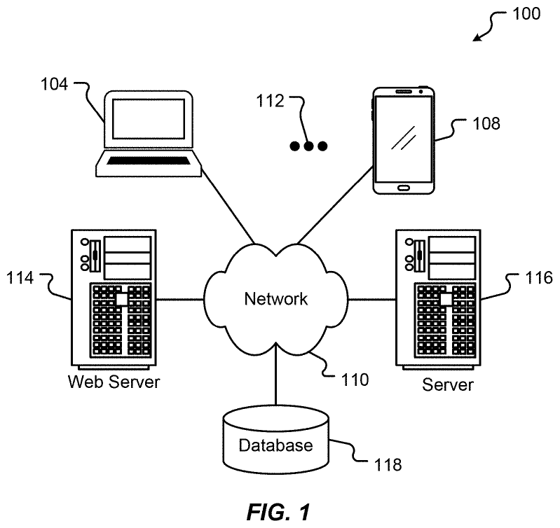

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

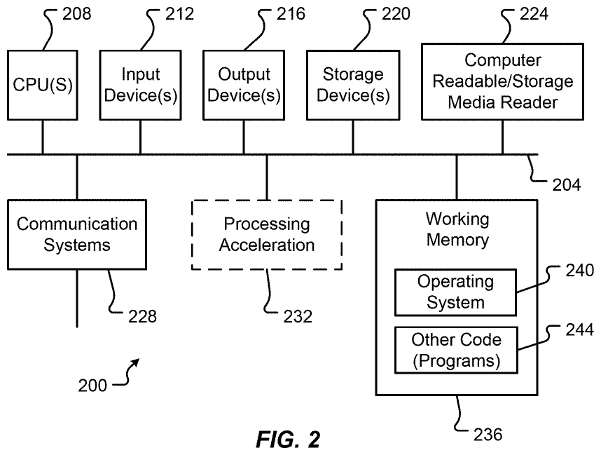

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

According to one embodiment, one or more servers and/or computing devices as described above can be adapted to manage one or more business processes and/or projects in a manner that gamifies the processes or project. That is, the employees of the business can be treated as a team and assigned points, either individually or to the team, as they complete tasks related to the project or operation of the business more generally. Not only does this approach assist with automating the management of the various projects and/or processes of operating the business, but it helps to keep the employees engaged, on task, and working together towards defined goals.

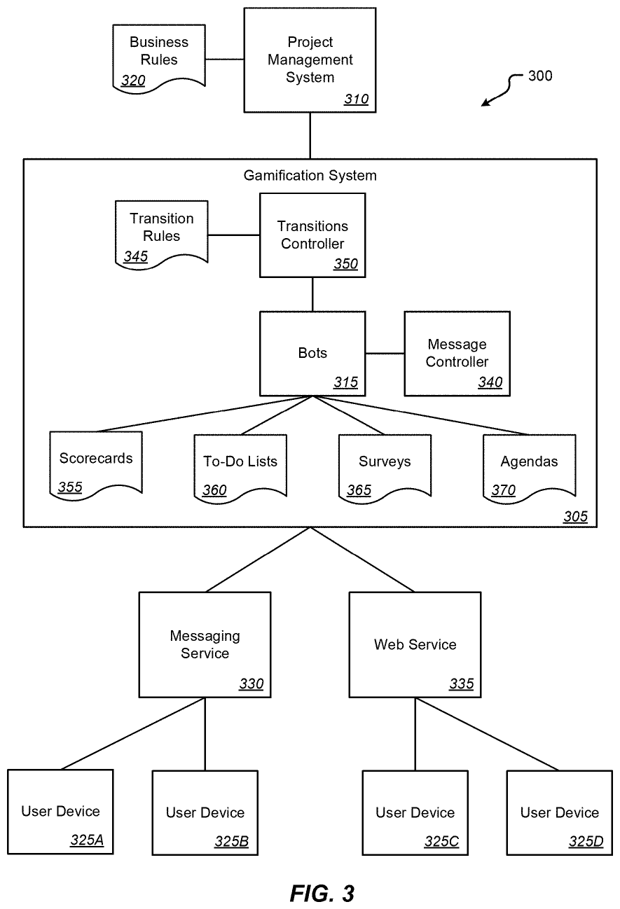

FIG. 3 is a block diagram illustrating elements of an exemplary environment 300 for implementing gamification of business processes according to one embodiment of the present disclosure. As illustrated in this example, the environment 300 can include a gamification system 305 which may be implemented on any one or more servers or other computing devices as described above. The gamification system 305 can utilize the services of a project management system 310 which can also be implemented on any one or more servers or other computing devices as described above. In some cases, the project management system 310 may be operated by another party and provided as a service. One example of such a service is Trello.

Generally speaking, the gamification system 305 can execute one or more bots 315 that utilize the services of the project management system 310 to manage any various processes of the business according to a set of business rules 320 defined for operation of the business, as known in the art, while adding game-like aspects such as score keeping for completed tasks. For example, the bots 315 can interface and interact with the project management system 310 via the Application Program Interface (API) provided by the project management system 310. In the provided example of the project management system 310 being implemented using Trello, and as known in the art, Trello provides a simple RESTful web API where each type of resource (e.g. a card, a board, or a member) has a URI that the bots 315 can interact with. As used herein, the term bot refers to a software application that is programmed to do certain tasks including, but not limited to, executing commands, replying to messages, or performing routine tasks, either automatically or with limited human intervention.

Scores and other aspects of this gamification, such as shout outs or high fives exchanged between team members to recognize accomplishments, can be communicated to user devices 325A-325D associated with each of the team members. Each user device 325A-325D can comprise a personal computer, laptop computer, tablet, mobile phone, or other computing device as described above. In some cases, these communications can be made through a messaging service 330 which can be provided by one or more servers or other computing devices as described above. In some cases, the messaging services 330 may be provided by a third party. One example of such a service is Slack. Additionally, or alternatively, messages may be sent to one or more user devices 325A-325D via a web server or web service 335.

A message controller 340 can control the messages send via the messaging service 330 and/or the web to fulfill business management functions for the business such as project management or surveying. For example, if the messaging service 330 is implemented using Slack, the message controller 340 can communicate with the user devices 325A-325D through Slack using the Slack API as known in the art. A set of rules 345 defining transitions can be applied by a transitions controller 350 on top of the project management system 310 and/or the message controller 340 to ensure that the way people are using the project management system 310 conforms to the processes of the business. Transitions refer to the transitions that would occur in a kanban such as Trello. Each transition can have a different meaning. For example, a transition that is not valid can have the system render a “Penalty.”

In operation, the employees of the business can be considered players of a game. As the players move tickets through the system, i.e., complete assigned tasks, they can be awarded points and assigned a score based on the action taken. The points can be maintained on a scorecard 355 for each employee/player and may be a factor in bonuses paid to the employee. In some cases, the points can be announced to other team members, e.g., through Slack or another messaging service 330. One or more bots 315 executed by the gamification system 305 can manage the points assigned to each member of the team as well as tracking to-do list 360s, goals, etc. for the team and individual team members. For example, the one or more bots 315 executed by the gamification system 305 can periodically check in with team members through questions or surveys 365 to query for the employee/player about the status of a task etc. Based on the answer(s) to these questions, the bots 315 can take various actions. For example, additional or different tasks can be assigned, an agenda 370 item can be added to an upcoming meeting, etc.

The one or more bots 315 executed by the gamification system 305 can also manage meetings between team members conducted through the messaging system 330. For example, the bots 315 can generate and maintain an agenda 370 for the meeting, track progress of the meeting, provide reminders of the allotted time for each topic, etc. The agenda 370 can be generated and update based on tasks completed or remaining to be done, to acknowledge shout outs and/or high fives exchanged between team members to acknowledge accomplishments, etc.

Any of the business processes performed can be implemented by the bots 315 of the gamification system 305. For example, one or more human resources processes can be executed and managed by the gamification system 305. In such cases, a bot 315 can, for example, initiate and manage an interview and hiring process for an open position by initiating an interview with a candidate, e.g., through a survey or series of surveys 365 exchanged with the candidate through the messaging system 330. Once a hiring decision is made, the gamification system 305 can similarly initiate an onboarding process which can involve, among other things, creating and tracking a to-do list 360 of tasks to complete onboarding, exchanging of surveys 365 and/or other messages through the messaging system 330, etc.

Stated another way, managing business processes according to embodiments described herein, i.e., by gamification of the business processes, can begin with reading, by a gamification system 305, a set of business process definitions and statuses from a project management system 310. The business process definitions, e.g., a set of business rules 320, can define a plurality of tasks. Each task of the plurality of tasks can be performed by one of more users of a plurality of users in the gamification system and can define a workflow for a project or particular business process of an enterprise. The statuses can indicate a current state of one or more tasks of the plurality of tasks, e.g., complete, incomplete, percentage complete.

The gamification system 305 can also maintain a set of transition rules 345. The transition rules 345 can define processes for transitioning items through the workflow defined in the business process definitions. For example, and as also noted above, the project management system 310 can be implemented in some cases on Trello. In such cases, the transition rules 345 can define actions for transitioning cards on a board in Trello or in on another, similar Kanban. The actions implemented by these transition rules 345, when executed by one or more bots 315 of the gamification system 305, can then initiate and manage communications, update and/or assign tasks, etc.

More specifically, the one or more bots 315 of the gamification system 305 can manage scoring of each user of the plurality of users in the gamification system 305 based on the business process definitions and statuses and by applying the set of transition rules 345. Managing the scoring of each user of the plurality of users in the gamification system can comprise maintaining a task list, e.g., a to-do list 360, for each user of the plurality of users based on the tasks defined in the business process definitions. The one or more bots 315 of the gamification system 305 can then monitor the task list or to-do list 360 for each user of the plurality of users based on the current state of the one or more tasks of the plurality of tasks in the business process statuses and determine, based on the monitoring of the tasks lists or to-do list 360 for each user of the plurality of users, whether a completed task exists in the task list or to-do list 360 for a user of the plurality of users. In response to determining a completed task exists in the task list or to-do list 360 for the user, the bots 315 of the gamification system 305 can accumulate achievement points for the user, e.g., in a scorecard 355 for that user.

Additionally, or alternatively, managing the scoring of each user of the plurality of users in the gamification system can comprise determining, by one or more bots 315 of the gamification system 305, based on the monitoring of the tasks lists or to-do list 360 for each user of the plurality of users, whether an incomplete task exists in the task list or to-do list 360 for a user of the plurality of users. In response to determining the incomplete task exists in the task list or to-do list 360 for the user, one or more bots 315 can initiate a communication with the user, e.g., through the messaging service 330 and/or web service 335.

In some cases, the one or more bots 315 can additionally, or alternatively, update a meeting agenda. For example, the meeting agenda can be updated based on one or more completed tasks, one or more incomplete tasks, etc.

The one or more bots 315 of the gamification system 305 can additionally, or alternatively, manage communications with one or more users of the plurality of users in the gamification system 305 based on the business process definitions and statuses and by applying the set of transition rules 345. Managing communications with user of the plurality of users in the gamification system 305 can comprise determining, by one or more bots 315 of the gamification system 305, whether to provide an update to one or more users of the plurality of users in the gamification system, e.g., based on a completed task, a “shout-out” or other communication, etc. In response to determining to provide the update to the one or more users of the plurality of users in the gamification system 305, the one or more bots 315 can generate the update and provide the update to the one or more user devices 325A-325D through the messaging service 330 and/or web service 335.

Additionally, or alternatively, managing communications with user of the plurality of users in the gamification system 305 can comprise determining by one or more bots 315 whether to collect information regarding one or more tasks of the plurality of tasks defined in the business process definitions from a user of the plurality of users, e.g., based on the status of the task, etc. In response to determining to collect the information regarding the one or more tasks from the user, the one or more bots 315 of the gamification system 301 can generate a survey 365 requesting the information regarding the one or more tasks, provide the generated survey to the user device 325A or 325C for the user through the messaging service 330 or web service 335, and receive one or more answers to the provided survey from the user device 325A or 325C through the messaging service 330 or web service 335.

In some cases, the transition rules 345 can define addition actions to be performed by the bots 315 based on the survey answers. For example, managing communications with user of the plurality of users in the gamification system 305 can additionally, or alternatively, comprise performing at least one of initiating additional communications with the user, e.g., a communication with another user, a follow-up survey or question to the same user, etc., and/or updating one or more tasks of a task list or to-do list 360 for the user based on the received one or more answers to the provided survey, e.g., the mark a task complete or incomplete, add a new task, modify an existing task, etc. Additionally, or alternatively, managing communications with user of the plurality of users in the gamification system 305 can comprise updating a meeting agenda 370 based on the received one or more answers to the provided survey, e.g., adding an agenda item.

Additionally, or alternatively, the one or more bots 315 of the gamification system 305 can manage meetings between the plurality of users in the gamification system 305 based on the business process definitions and statuses and by applying the set of transition rules 345. Managing the meetings between the plurality of users in the gamification system 305 can comprise maintaining by one or more bots 315 a meeting agenda 370 defining topics for a meeting and a schedule for the meeting. The one or more bots 315 can then initiate the meeting with two or more users of the plurality of users in the gamification system 305 at the scheduled time, e.g., as a message to each user through the messaging service 330 and/or web service 335 at a time indicated in the schedule for the meeting.

The one or more bots 315, e.g., using NLP routines as known in the art, can then monitor communications between the two or more users through the messaging service 330 and/or web service 335 during the meeting. Based on the monitoring of the communication between the two or more users during the meeting, the one or more bots 315 can update a score of a user, e.g., based on NLP recognition of a compliment or other praise to or recognition of a user, or may update a task in a task list or to-do list 360 for a user, e.g., based on NLP recognition of discussion of a task to be assigned. In some cases, managing the meetings between the plurality of users in the gamification system 305 can additionally, or alternatively, comprise determining by one or more bots 315, based on the monitoring of the meeting, whether the meeting is following the agenda for the meeting, e.g., based on NLP recognition of keywords and/or topics etc. In response to determining the meeting is not following the agenda for the meeting, the one or more bots 315 can provide a prompt to the two or more users through the messaging service 330 and/or web service 335.

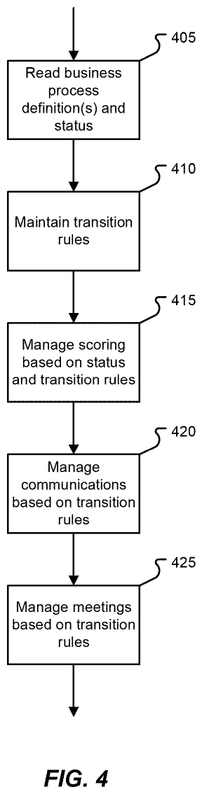

FIG. 4 is a flowchart illustrating an exemplary process for gamification of business processes according to one embodiment of the present disclosure. As illustrated in this example, managing business processes according to embodiments described herein, i.e., by gamification of the business processes, can begin with reading 405, by a gamification system 305, a set of business process definitions and statuses from a project management system 310. The business process definitions, e.g., a set of business rules 320, can define a plurality of tasks. Each task of the plurality of tasks can be performed by one of more users of a plurality of users in the gamification system and can define a workflow. The statuses can indicate a current state of one or more tasks of the plurality of tasks, e.g., complete, incomplete, percentage complete.

The gamification system 305 can also maintain 410 a set of transition rules 345. As noted above, the transition rules 345 can define processes for transitioning items through the workflow defined in the business process definitions. For example, and as also noted above, the project management system 310 can be implemented in some cases on Trello. In such cases, the transition rules 345 can define actions for transitioning cards on a board in Trello in on another, similar Kanban. The actions implemented by these transition rules 345, when executed by one or more bots 315 of the gamification system 305, can then initiate and manage communications, update and/or assign tasks, etc.

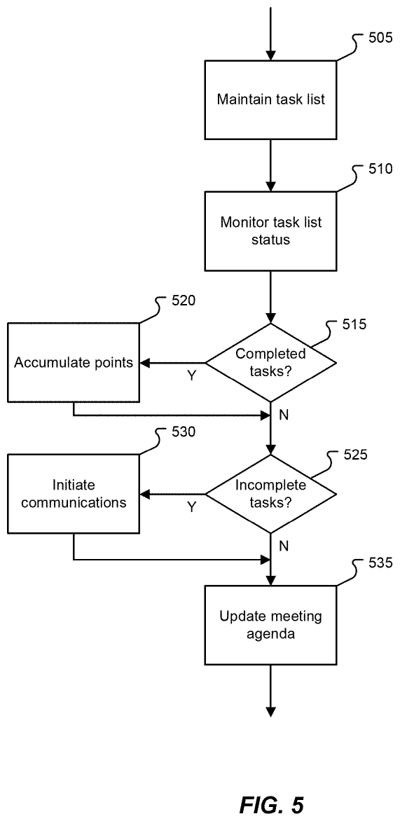

More specifically, the one or more bots 315 of the gamification system 305 can manage 415 scoring of each user of the plurality of users in the gamification system 305 based on the business process definitions and statuses and by applying the set of transition rules 345. Additional details of an exemplary process for managing 415 scoring according to one embodiment will be described below with reference to FIG. 5.

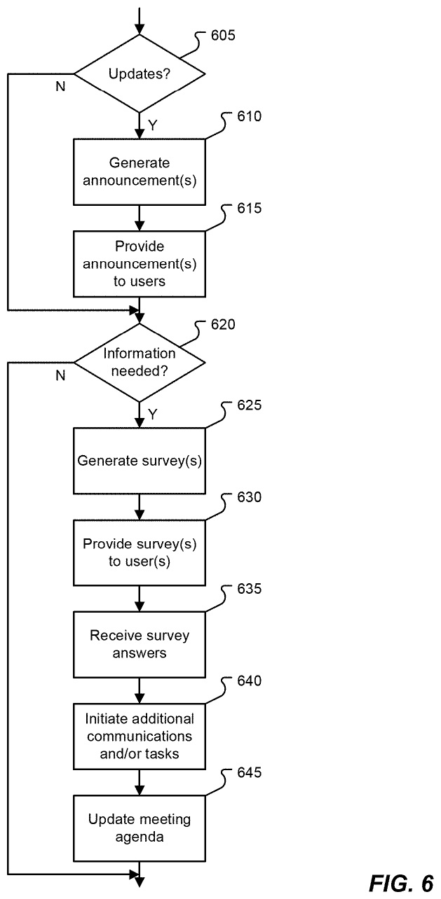

The one or more bots 315 of the gamification system 305 can additionally, or alternatively, manage 420 communications with one or more users of the plurality of users in the gamification system 305 based on the business process definitions and statuses and by applying the set of transition rules 345. Additional details of an exemplary process for managing 420 communications according to one embodiment will be described below with reference to FIG. 6.

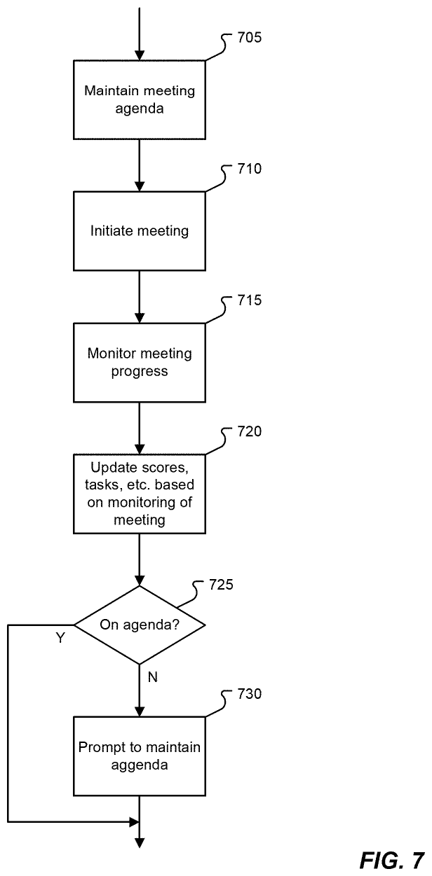

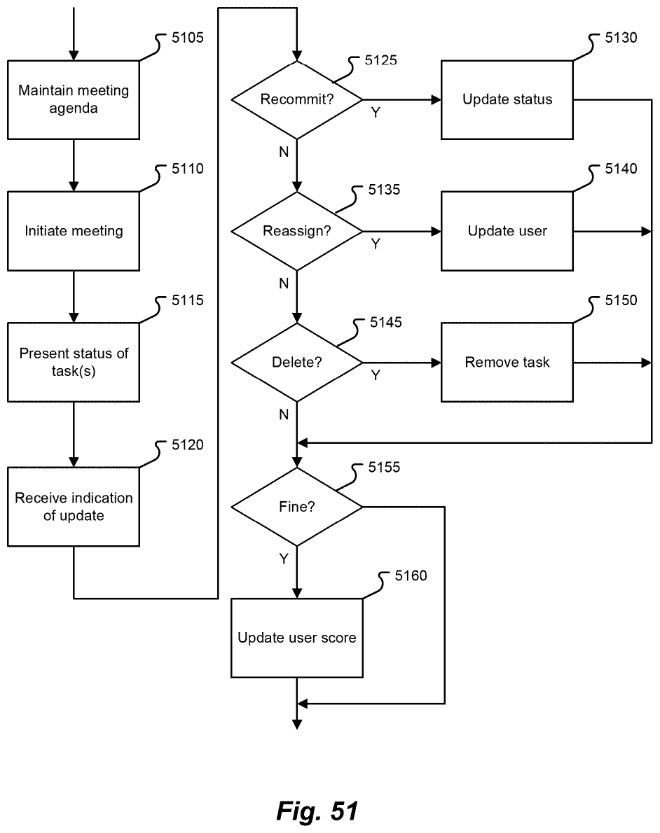

Additionally, or alternatively, the one or more bots 315 of the gamification system 305 can manage 425 meetings between the plurality of users in the gamification system 305 based on the business process definitions and statuses and by applying the set of transition rules 345. Additional details of an exemplary process for managing 425 meetings according to one embodiment will be described below with reference to FIG. 7. According to one embodiment, managing 425 a meeting can additionally, or alternatively comprise comprises updating the status or the business process definition for one or more tasks of the plurality of tasks as will be described in greater detail below with reference to FIG. 51.

FIG. 5 is a flowchart illustrating an exemplary process for managing scoring within gamification of business processes according to one embodiment of the present disclosure. As illustrated in this example, managing the scoring of each user of the plurality of users in the gamification system can comprise maintaining 505 a task list, e.g., a to-do list 360, for each user of the plurality of users based on the tasks defined in the business process definitions. The one or more bots 315 of the gamification system 305 can then monitor 510 the task list or to-do list 360 for each user of the plurality of users based on the current state of the one or more tasks of the plurality of tasks in the business process statuses and determine 515, based on the monitoring 510 of the tasks lists or to-do list 360 for each user of the plurality of users, whether a completed task exists in the task list or to-do list 360 for a user of the plurality of users. In response to determining 515 a completed task exists in the task list or to-do list 360 for the user, the bots 315 of the gamification system 305 can accumulate 520 achievement points for the user, e.g., in a scorecard 355 for that user.

Additionally, or alternatively, managing the scoring of each user of the plurality of users in the gamification system can comprise determining 525, by one or more bots 315 of the gamification system 305, based on the monitoring 510 of the tasks lists or to-do list 360 for each user of the plurality of users, whether an incomplete task exists in the task list or to-do list 360 for a user of the plurality of users. In response to determining 525 the incomplete task exists in the task list or to-do list 360 for the user, one or more bots 315 can initiate 530 a communication with the user, e.g., through the messaging service 330 and/or web service 335.

In some cases, the one or more bots 315 can additionally, or alternatively, update 535 a meeting agenda. For example, the meeting agenda can be updated based on one or more completed tasks, one or more incomplete tasks, etc.

FIG. 6 is a flowchart illustrating an exemplary process for managing communications within gamification of business processes according to one embodiment of the present disclosure. As illustrated in this example, managing communications with user of the plurality of users in the gamification system 305 can comprise determining 605, by one or more bots 315 of the gamification system 305, whether to provide an update to one or more users of the plurality of users in the gamification system, e.g., based on a completed task, a “shout-out” or other communication, etc. In response to determining 605 to provide the update to the one or more users of the plurality of users in the gamification system 305, the one or more bots 315 can generate 610 the update and provide 615 the update to the one or more user devices 325A-325D through the messaging service 330 and/or web service 335.

Additionally, or alternatively, managing communications with user of the plurality of users in the gamification system 305 can comprise determining 620 by one or more bots 315 whether to collect information regarding one or more tasks of the plurality of tasks defined in the business process definitions from a user of the plurality of users, e.g., based on the status of the task, etc. In response to determining 620 to collect the information regarding the one or more tasks from the user, the one or more bots 315 of the gamification system 301 can generate 625 a survey 365 requesting the information regarding the one or more tasks, provide 630 the generated survey to the user device 325A or 325C for the user through the messaging service 330 or web service 335, and receive 635 one or more answers to the provided survey from the user device 325A or 325C through the messaging service 330 or web service 335.

In some cases, the transition rules 345 can define addition actions to be performed by the bots 315 based on the survey answers. For example, managing communications with user of the plurality of users in the gamification system 305 can additionally, or alternatively, comprise performing 640 at least one of initiating additional communications with the user, e.g., a communication with another user, a follow-up survey or question to the same user, etc., and/or updating one or more tasks of a task list or to-do list 360 for the user based on the received one or more answers to the provided survey, e.g., the mark a task complete or incomplete, add a new task, modify an existing task, etc. Additionally, or alternatively, managing communications with user of the plurality of users in the gamification system 305 can comprise updating 645 a meeting agenda 370 based on the received one or more answers to the provided survey, e.g., adding an agenda item.

FIG. 7 is a flowchart illustrating an exemplary process for managing meetings within gamification of business processes according to one embodiment of the present disclosure. As illustrated in this example, managing the meetings between the plurality of users in the gamification system 305 can comprise maintaining 705 by one or more bots 315 a meeting agenda 370 defining topics for a meeting and a schedule for the meeting. The one or more bots 315 can then initiate 710 the meeting with two or more users of the plurality of users in the gamification system 305 at the scheduled time, e.g., as a message to each user through the messaging service 330 and/or web service 335 at a time indicated in the schedule for the meeting.

The one or more bots 315, e.g., using NLP routines as known in the art, can then monitor 715 communications between the two or more users through the messaging service 330 and/or web service 335 during the meeting. Based on the monitoring 715 of the communication between the two or more users during the meeting, the one or more bots 315 can update a score of a user, e.g., based on NLP recognition of a compliment or other praise to or recognition of a user, or may update a task in a task list or to-do list 360 for a user, e.g., based on NLP recognition of discussion of a task to be assigned. In some cases, managing the meetings between the plurality of users in the gamification system 305 can additionally, or alternatively, comprise determining 725 by one or more bots 315, based on the monitoring 715 of the meeting, whether the meeting is following the agenda for the meeting, e.g., based on NLP recognition of keywords and/or topics etc. In response to determining 725 the meeting is not following the agenda for the meeting, the one or more bots 315 can provide 730 a prompt to the two or more users through the messaging service 330 and/or web service 335.

For illustrative purposes, a series of exemplary user interfaces as may be presented by a gamification system 305 according to various embodiments described herein will now be described. It should be understood that the user interfaces illustrated in the Figures and described below are provided by way of example for illustrative purposes only and are not intended to limit the scope of the present disclosure. Rather, the interfaces can vary significantly in different implementations without departing from the scope of the present disclosure. For example, the interfaces may have more, fewer, and/or different elements and other content, different formats, etc. Such variations are considered to be within the scope of the present disclosure.

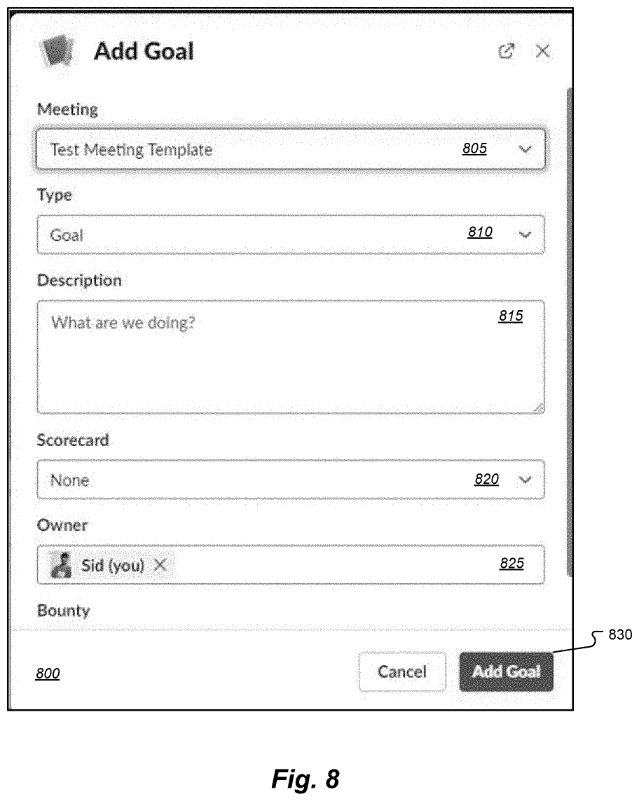

FIGS. 8-38 are screenshots illustrating exemplary user interfaces for conducting meetings according to one embodiment of the present disclosure. More specifically, FIG. 8 is a screenshot illustrating an exemplary user interface for adding a goal according to one embodiment of the present disclosure. As illustrated in this example, the interface can comprise a dialog box 800, including a number of elements. In this example, the elements include a “Meeting” combo-box 805 for selecting a meeting to which the goal will be added, a “Type” combo-box 810 for selecting a goal type, a “Description” textbox 815 for adding a text description of the goal, a “Scorecard” combo-box 820 for selecting a scorecard of an individual related to the goal, an “Owner” textbox 825 for identifying the owner of the goal, and one or more buttons 830 for cancelling or adding the goal.

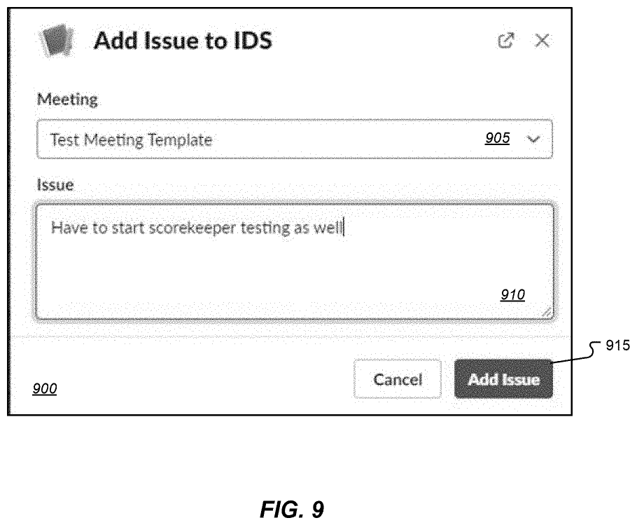

FIG. 9 is a screenshot illustrating an exemplary user interface for adding an issue according to one embodiment of the present disclosure. As illustrated in this example, the interface can comprise a dialog box 900, including a number of elements. In this example, the elements include a “Meeting” combo-box 905 for selecting a meeting to which the issue will be added, a “Description” textbox 910 for adding a text description of the issue, and one or more buttons 915 for cancelling or adding the issue.

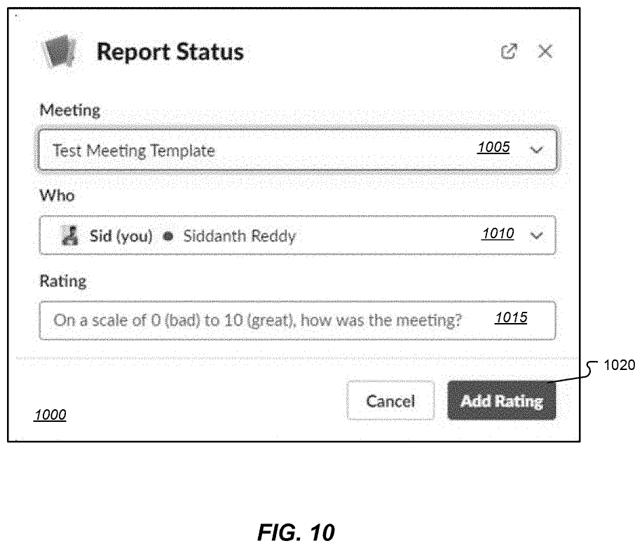

FIG. 10 is a screenshot illustrating an exemplary user interface for adding a rating according to one embodiment of the present disclosure. As illustrated in this example, the interface can comprise a dialog box 1000, including a number of elements. In this example, the elements include a “Meeting” combo-box 1005 for selecting a meeting to which the rating will be added, a “Who” textbox 910 for adding a text identifying the user providing the rating, and one or more buttons 915 for cancelling or adding the rating.

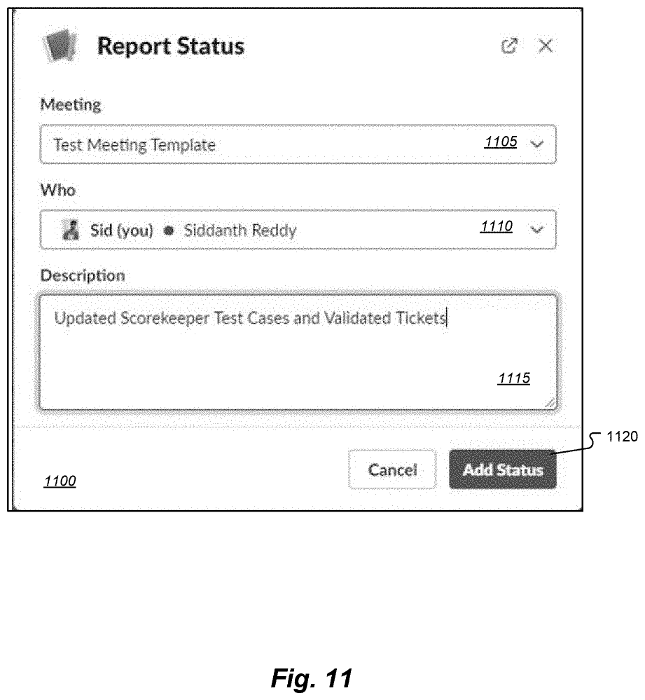

FIG. 11 is a screenshot illustrating an exemplary user interface for adding a status according to one embodiment of the present disclosure. As illustrated in this example, the interface can comprise a dialog box 1100, including a number of elements. In this example, the elements include a “Meeting” combo-box 1105 for selecting a meeting to which the status will be added, a “Who” textbox 1110 for adding a text identifying the user providing the status, a “Description” textbox 1115 for adding a text description of the status, and one or more buttons 1120 for cancelling or adding the status.

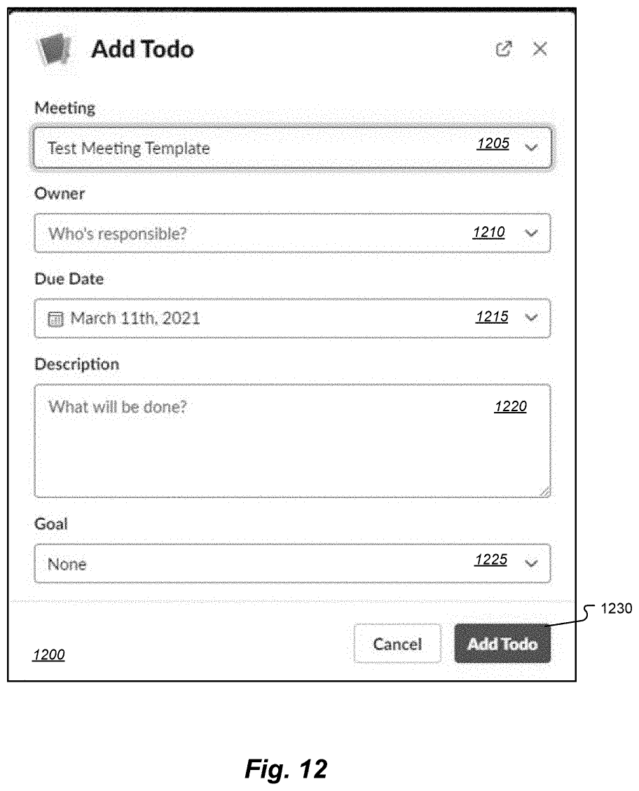

FIG. 12 is a screenshot illustrating an exemplary user interface for adding a task according to one embodiment of the present disclosure. As illustrated in this example, the interface can comprise a dialog box 1200, including a number of elements. In this example, the elements include a “Meeting” combo-box 1205 for selecting a meeting to which the task or to-do will be added, an “Owner” combo-box 1210 for selecting a user responsible for the to-do, a “Due Date” combo-box 1215 for selecting a due date for the to do, a “Description” textbox 1220 for adding a text description of the to do, a “Goal” combo-box 1225 for identifying the a goal for the to do, and one or more buttons 1230 for cancelling or adding the to do.

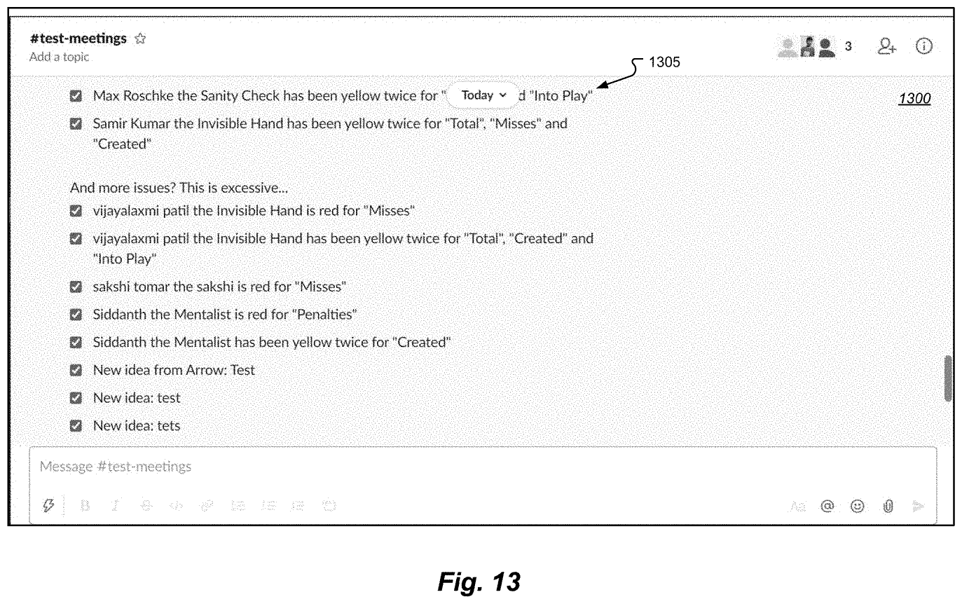

FIG. 13 is a screenshot illustrating an exemplary user interface for updating an addressed issue according to one embodiment of the present disclosure. As illustrated in this example, the interface can comprise a dialog box 1300, including a list 1305 of addressed issues as may be generated and/or updated by one or more bots 315 and/or users.

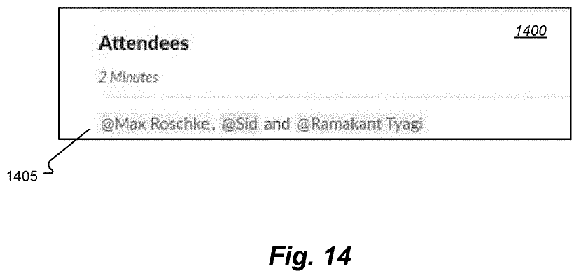

FIG. 14 is a screenshot illustrating an exemplary user interface for a meeting attendees list according to one embodiment of the present disclosure. As illustrated in this example, the interface can comprise a dialog box 1400, including a list 1405 of meeting attendees as may be generated and/or updated by one or more bots 315 and/or users.

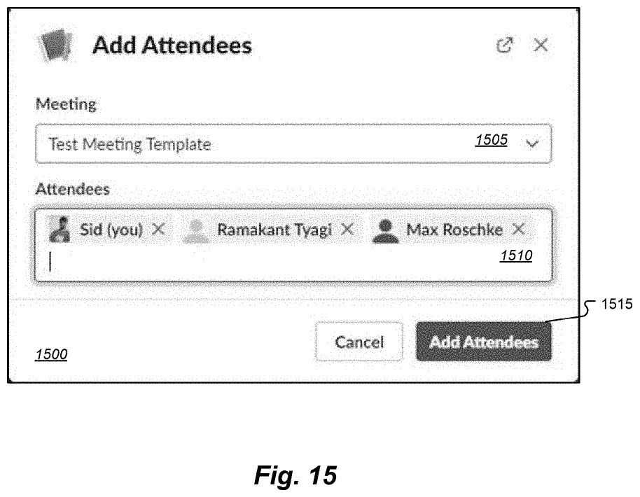

FIG. 15 is a screenshot illustrating an exemplary user interface for adding attendees to a meeting according to one embodiment of the present disclosure. As illustrated in this example, the interface can comprise a dialog box 1500, including a number of elements. In this example, the elements include a “Meeting” combo-box 1505 for selecting a meeting to which the attendees will be added, an “Attendees” textbox 1510 for adding a text identifying the users attending the meeting, and one or more buttons 1515 for cancelling the dialog or adding the attendees.

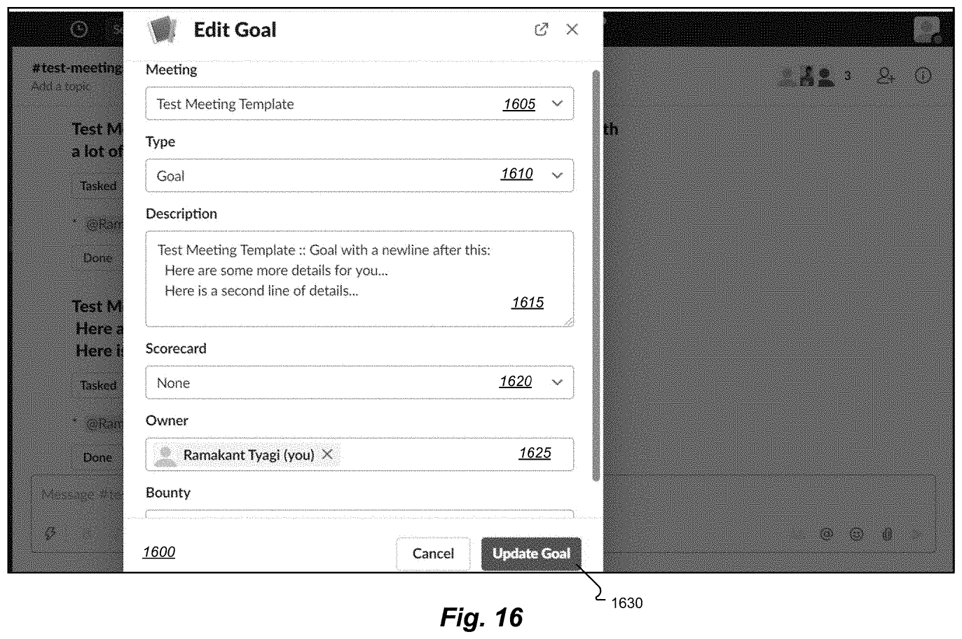

FIG. 16 is a screenshot illustrating an exemplary user interface for editing a goal according to one embodiment of the present disclosure. As illustrated in this example, the interface can comprise a dialog box 1600, including a number of elements. In this example, the elements include a “Meeting” combo-box 1605 for selecting a meeting to which the goal relates, a “Type” combo-box 1610 for selecting a goal type, a “Description” textbox 1615 for adding or editing a text description of the goal, a “Scorecard” combo-box 1620 for selecting a scorecard of an individual related to the goal, an “Owner” textbox 1625 for identifying the owner of the goal, and one or more buttons 1630 for cancelling the dialog or updating the goal.

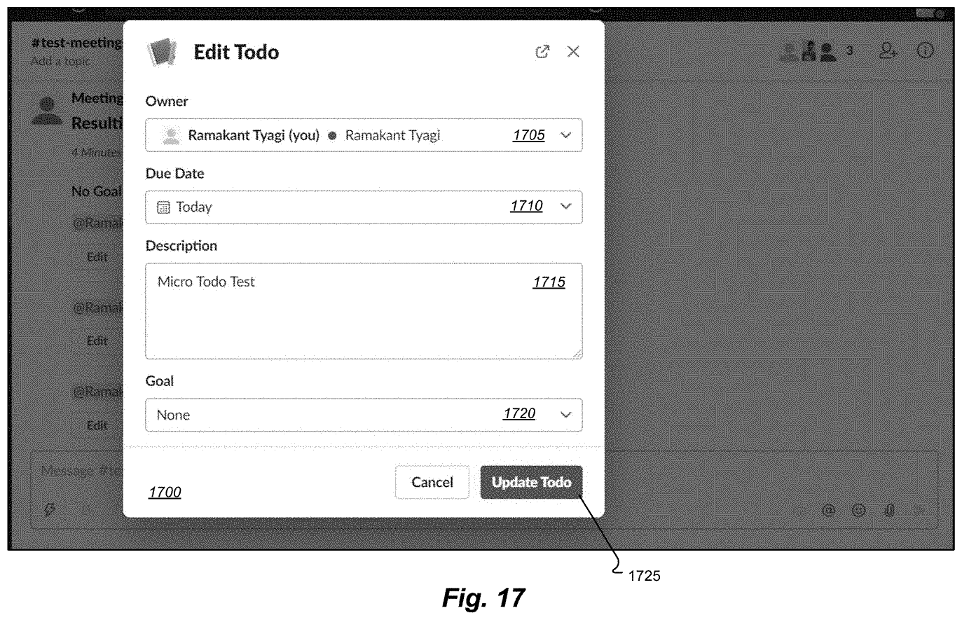

FIG. 17 is a screenshot illustrating an exemplary user interface for editing a task according to one embodiment of the present disclosure. As illustrated in this example, the interface can comprise a dialog box 1700, including a number of elements. In this example, the elements include an “Owner” combo-box 1705 for selecting a user responsible for the to-do, a “Due Date” combo-box 1710 for selecting a due date for the to do, a “Description” textbox 1715 for adding or editing a text description of the to do, a “Goal” combo-box 1720 for identifying the a goal for the to do, and one or more buttons 1725 for cancelling the dialog or updating the to do.

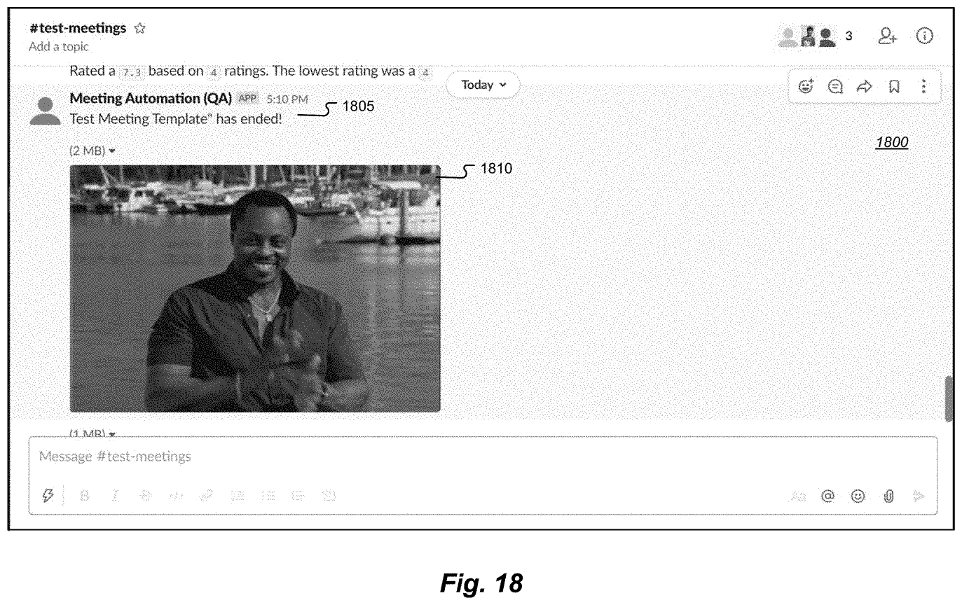

FIG. 18 is a screenshot illustrating an exemplary user interface for ending a meeting according to one embodiment of the present disclosure. As illustrated in this example, the interface can comprise a dialog box 1800, including a number of elements. In this example, the elements include a text message 1805 that the meeting has ended. The dialog box 1800 may also include a link 1810 to a recording of the meeting.

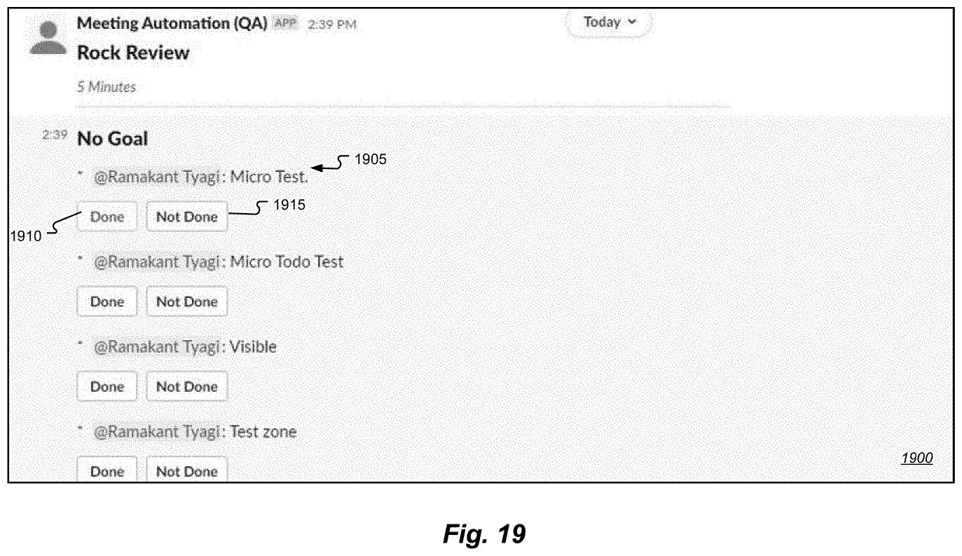

FIG. 19 is a screenshot illustrating an exemplary user interface for a goal list according to one embodiment of the present disclosure. As illustrated in this example, the interface can comprise a dialog box 1900, including a number of elements. In this example, the elements include a list of one or more goals 1905. Each goal 1905 of the list can be followed by a “Done” button 1910 and a “Not Done” button 1915 the user can click to indicate the current status of the associated goal.

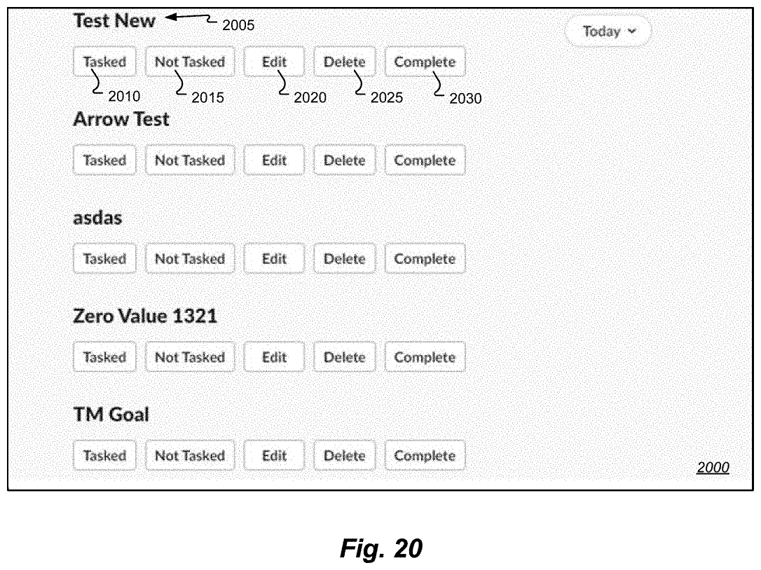

FIG. 20 is a screenshot illustrating an exemplary user interface for a goal list according to another embodiment of the present disclosure. As illustrated in this example, the interface can comprise a dialog box 2000, including a number of elements. In this example, the elements include a list of one or more goals 2005. Each goal 2005 of the list can be followed by a “Tasked” button 1910, a “Not Tasked” button 2015, an “Edit” button 2020, a “Delete” button 2025, and a “Complete” button 2030 any of which the user can click to modify the associated goal.

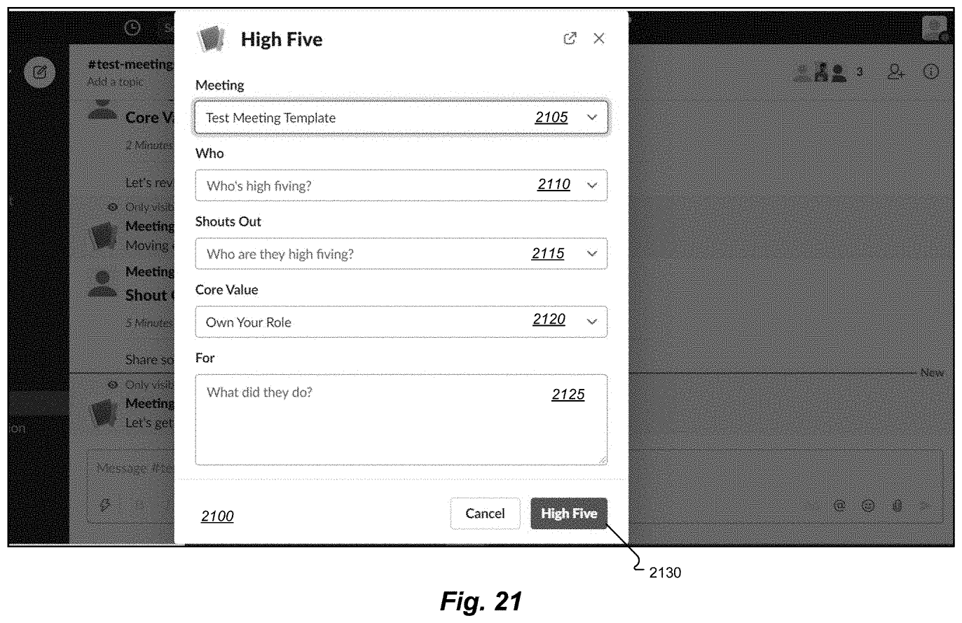

FIG. 21 is a screenshot illustrating an exemplary user interface for giving a high five according to one embodiment of the present disclosure. As illustrated in this example, the interface can comprise a dialog box 2100, including a number of elements. In this example, the elements include a “Meeting” combo-box 2105 for selecting a meeting in which the high five or other praise will be noted, a “Who” combo-box 2110 for selecting a user giving the high five, a “Shout Out” combo-box 2115 for selecting a user to receive the high five, a “Core Value” combo-box 2120 for selecting value of the individual or organization forming the basis of the high five, a “For” textbox 2125 for describing the reason for the high five, and one or more buttons 2130 for cancelling the dialog or giving the high five or praise.

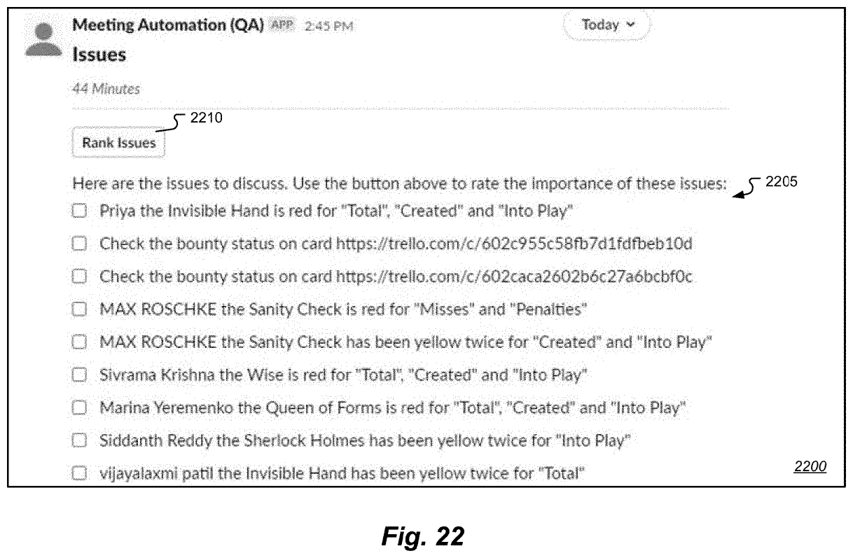

FIG. 22 is a screenshot illustrating an exemplary user interface for an issues list according to one embodiment of the present disclosure. As illustrated in this example, the interface can comprise a dialog box 2200, including a number of elements. In this example, the elements include a list 2205 of issues as may be identified by one or more users as described above. The dialog box 2200 can also include a button 2210 that can be pressed to rank or order the issues.

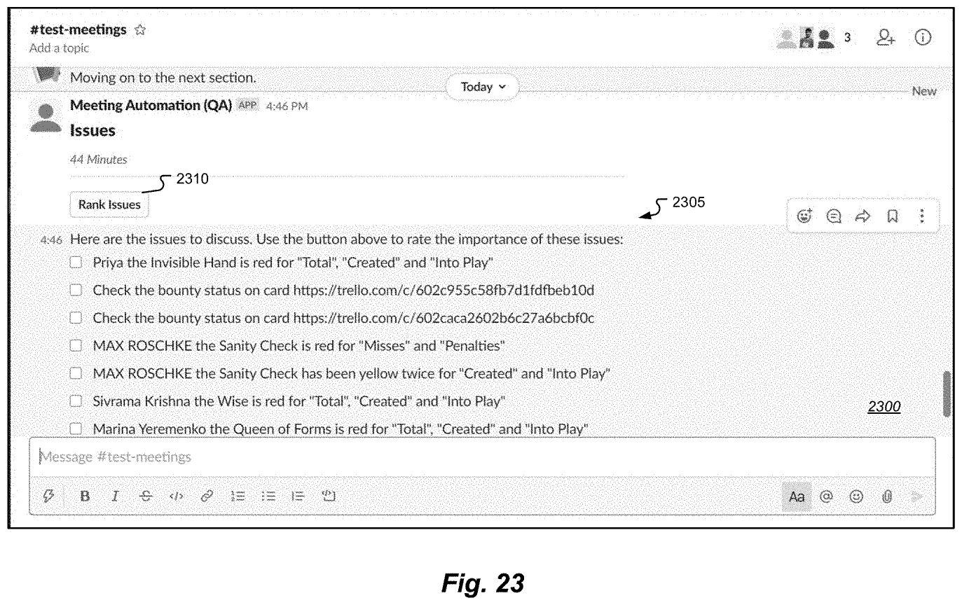

FIG. 23 is a screenshot illustrating an exemplary user interface for an issues list with issues automatically added by a bot according to one embodiment of the present disclosure. As illustrated in this example, the interface can comprise a dialog box 2300, including a number of elements. In this example, the elements include a list 2305 of issues, some of which may be generated by one or more bots 315 as described above. The dialog box 2200 can also include a button 2310 that can be pressed to rank or order the issues.

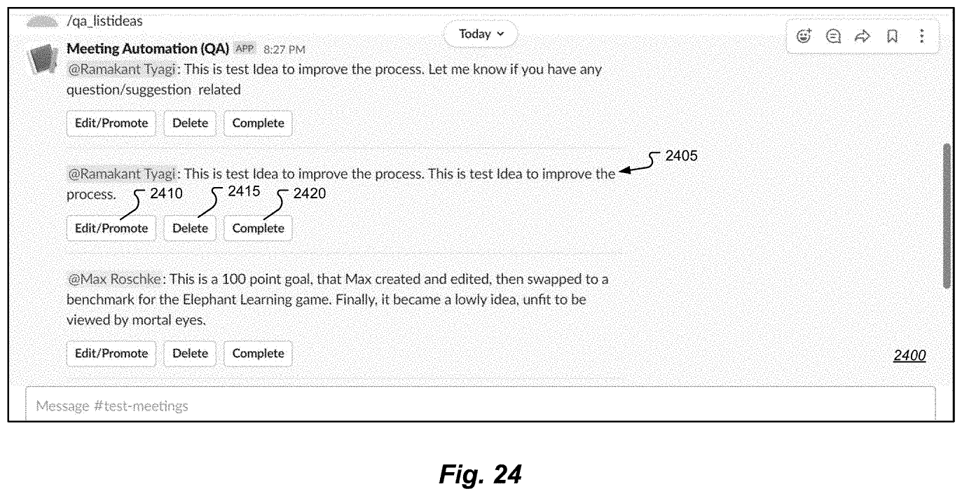

FIG. 24 is a screenshot illustrating an exemplary user interface for an ideas list according to one embodiment of the present disclosure. As illustrated in this example, the interface can comprise a dialog box 2400, including a number of elements. In this example, the elements include a list of one or more ideas 2405. Each idea 2405 of the list can be followed by a “Edit/Promote” button 2410, a “Delete” button 2415, and a “Complete” button 2420, any of which the user can click to modify the associated idea.

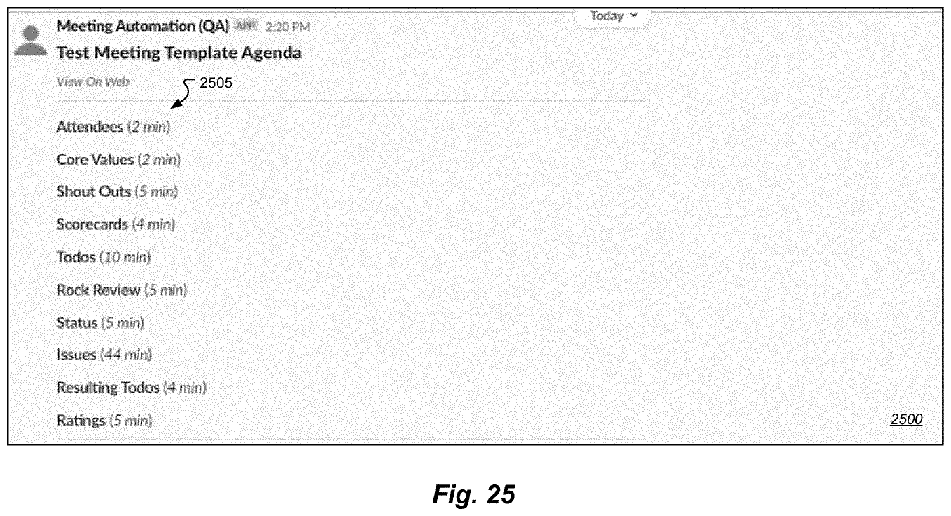

FIG. 25 is a screenshot illustrating an exemplary user interface for meeting agenda according to one embodiment of the present disclosure. As illustrated in this example, the interface can comprise a dialog box 2500. In this example, the dialog box 2500 include a list or schedule, i.e., an agenda, for the meeting as may be generated by one or more bots 315 as described herein.

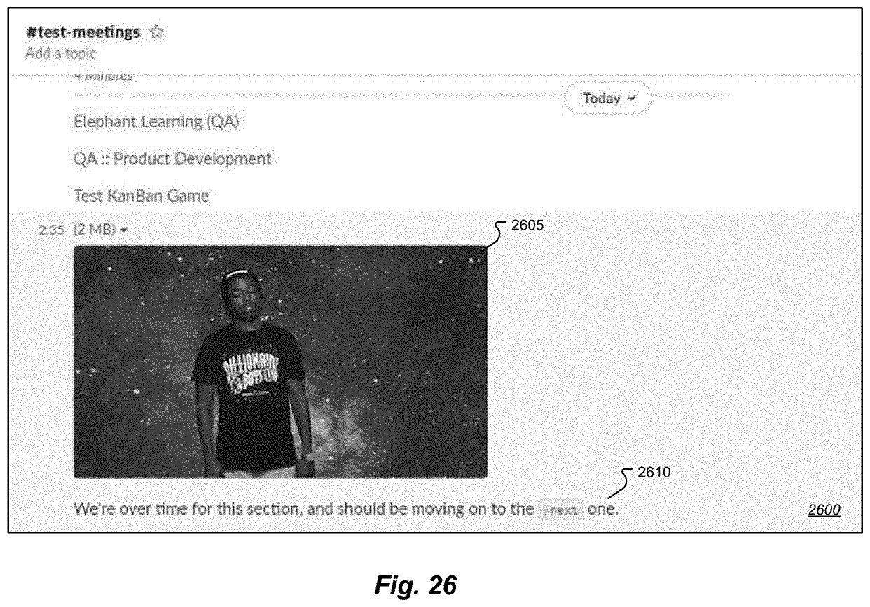

FIG. 26 is a screenshot illustrating an exemplary user interface for an overtime warning according to one embodiment of the present disclosure. As illustrated in this example, the interface can comprise a dialog box 2600, including a number of elements. In this example, the elements include a presentation 2605 of the meeting and a message or prompt 2610 as may be generated by a bot 315 as described herein.

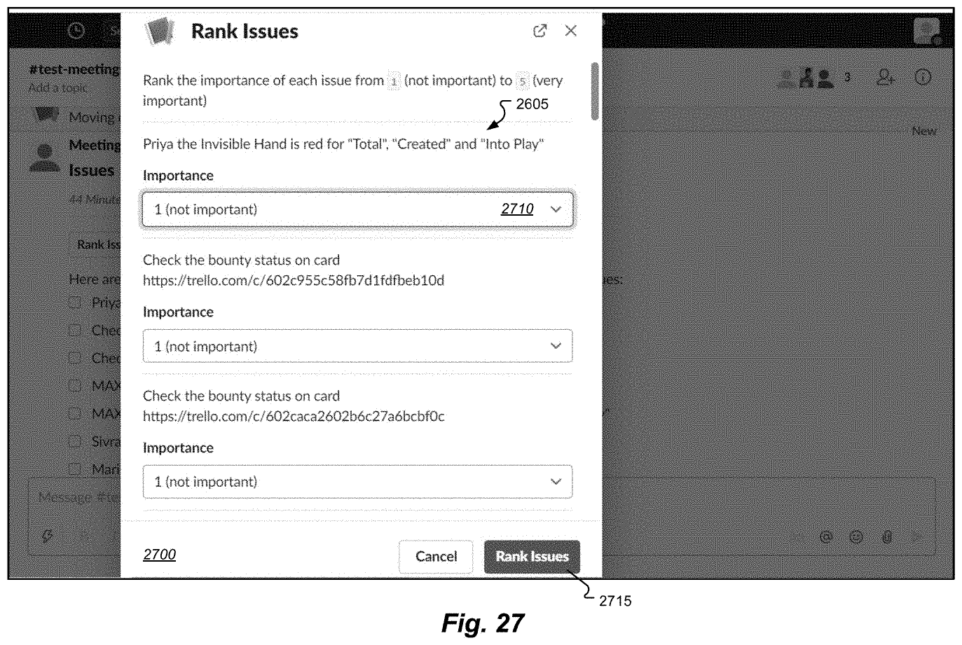

FIG. 27 is a screenshot illustrating an exemplary user interface for ranking issue importance according to one embodiment of the present disclosure. As illustrated in this example, the interface can comprise a dialog box 2700, including a number of elements. In this example, the elements include a list of one or more issues 2605, an “Importance” combo-box 2710 for selecting a ranking of importance for each issue, and one or more buttons 2715 for cancelling the dialog or ranking the issues.

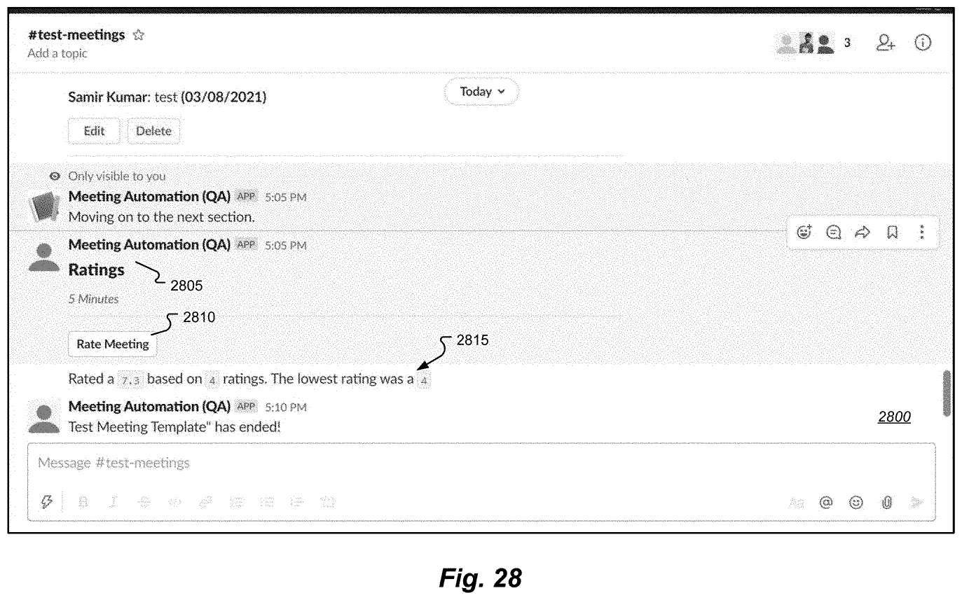

FIG. 28 is a screenshot illustrating an exemplary user interface for a rating summary according to one embodiment of the present disclosure. As illustrated in this example, the interface can comprise a dialog box 2800, including a number of elements. In this example, the elements include a “Ratings” heading above a “Rate Meeting” button 2810 to initiate or provide a rating, and text 2815 providing a summary of received ratings for the meeting.

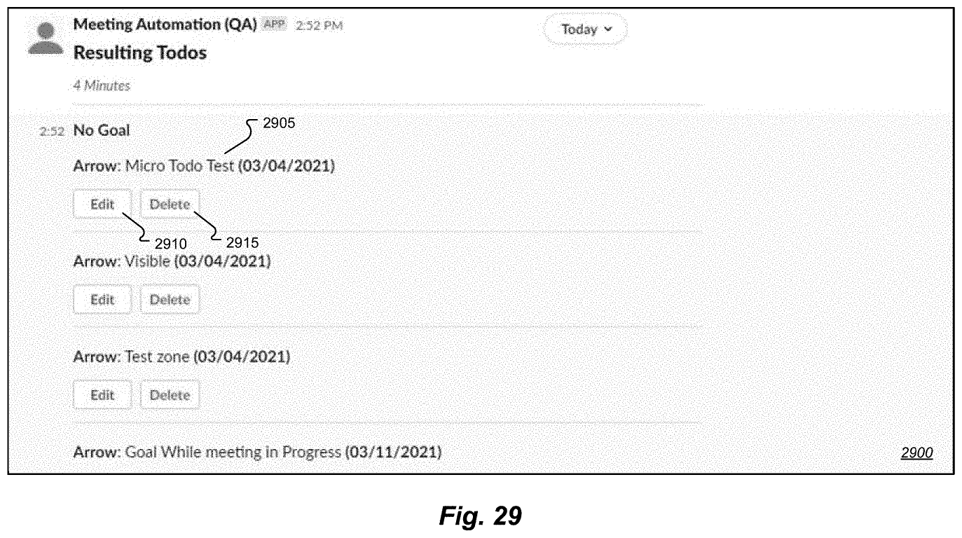

FIG. 29 is a screenshot illustrating an exemplary user interface for presenting tasks generated by a bot during a meeting according to one embodiment of the present disclosure. As illustrated in this example, the interface can comprise a dialog box 2900, including a number of elements. In this example, the elements include a list of one or more tasks 2905 generated by one or more bots 315 as described herein, e.g., by monitoring a meeting. Each generated task 2905 of the list can be followed by an : As illustrated in this example, the interface can comprise a dialog box 2800, including a number of elements. In this example, the elements include an “Edit” button 2910 and a “Delete” button that can be used to modify or remove the generated task.

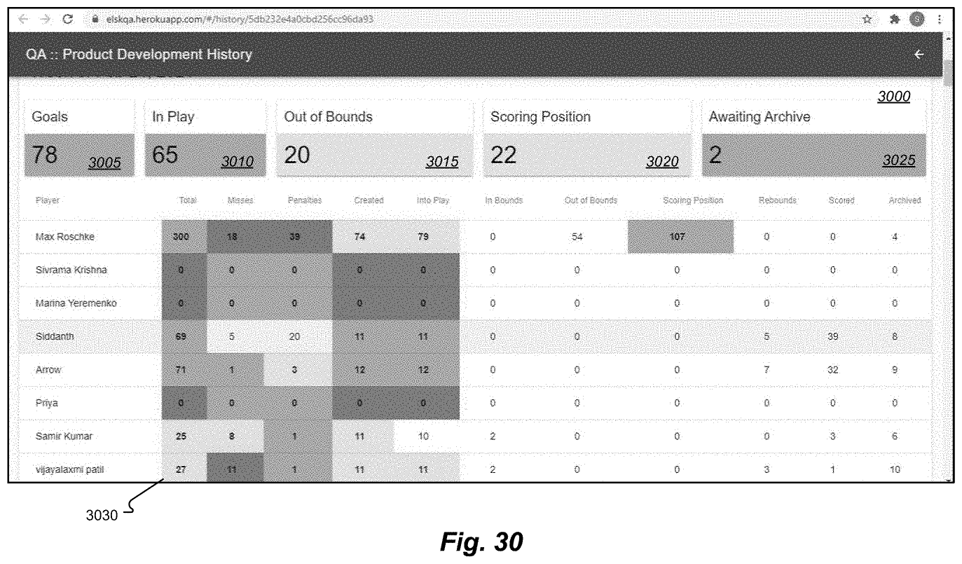

FIG. 30 is a screenshot illustrating an exemplary user interface for a scorecard according to one embodiment of the present disclosure. As illustrated in this example, the interface can comprise a dialog box 3000, including a number of elements. In this example, the elements include a summary of various metrics 3005, 3010, 3015, 3020, 3025 for a project and a table 3030 of metrics for individual users or individuals, e.g., employees.

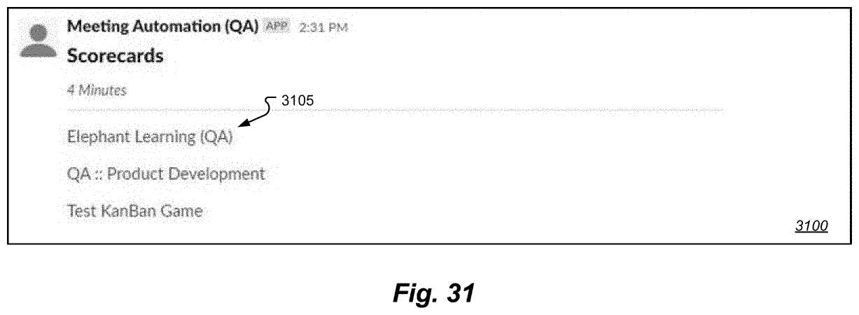

FIG. 31 is a screenshot illustrating an exemplary user interface for a scorecard list according to one embodiment of the present disclosure. As illustrated in this example, the interface can comprise a dialog box 3100, including a number of elements. In this example, the elements include a list of hyperlinks 3105 to individual scorecards.

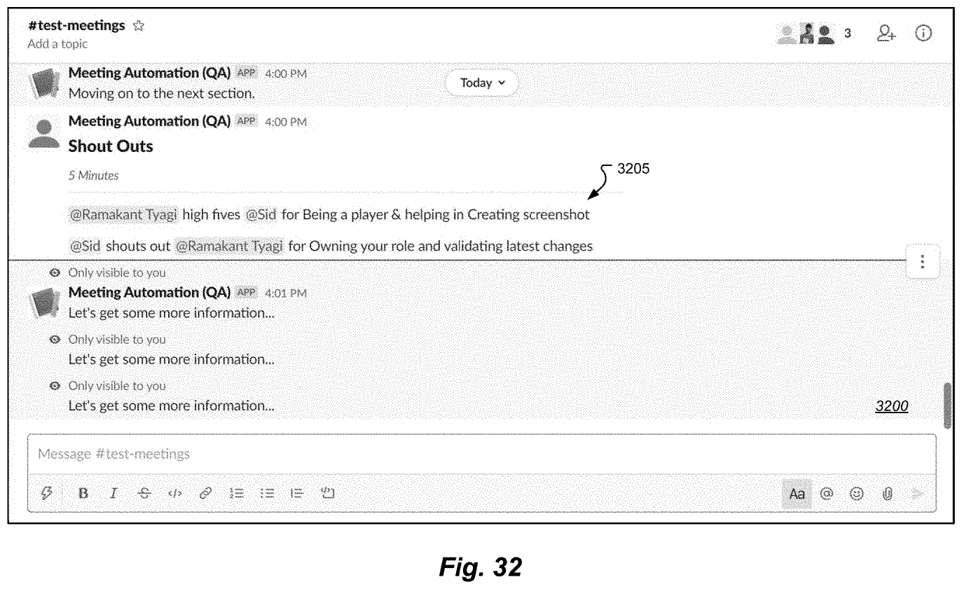

FIG. 32 is a screenshot illustrating an exemplary user interface for listing shout outs and high fives according to one embodiment of the present disclosure. As illustrated in this example, the interface can comprise a dialog box 3200, including a number of elements. In this example, the elements include a list of shout outs and/or high fives 3205 or similar communications of praise from and to individuals.

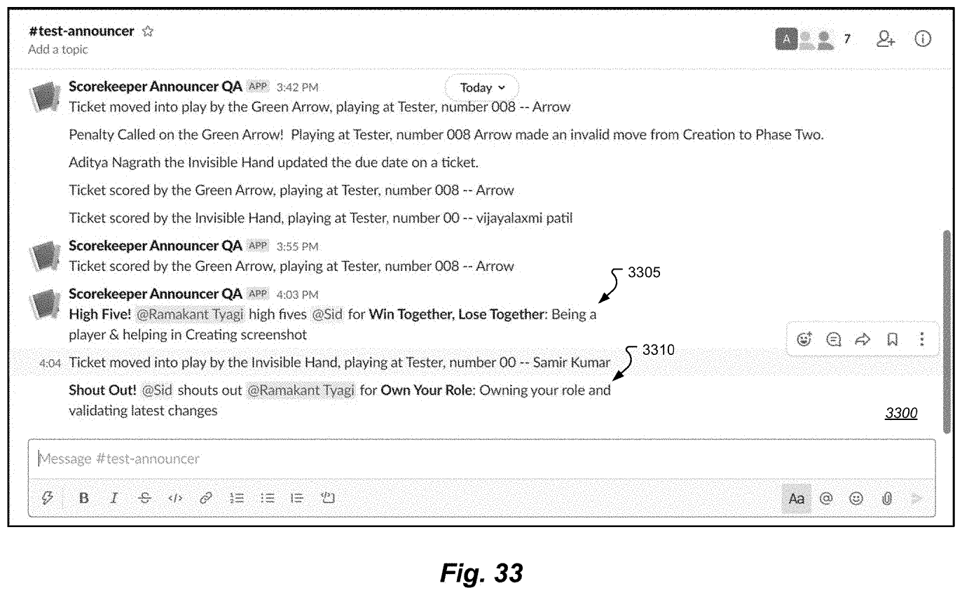

FIG. 33 is a screenshot illustrating an exemplary user interface for presenting shout outs and high fives in a team channel according to one embodiment of the present disclosure. As illustrated in this example, the interface can comprise a dialog box 3300, including a number of elements. In this example, the elements include a list of communications between members of a team including shout outs and/or high fives 3205 or similar communications of praise from and to individual team members.

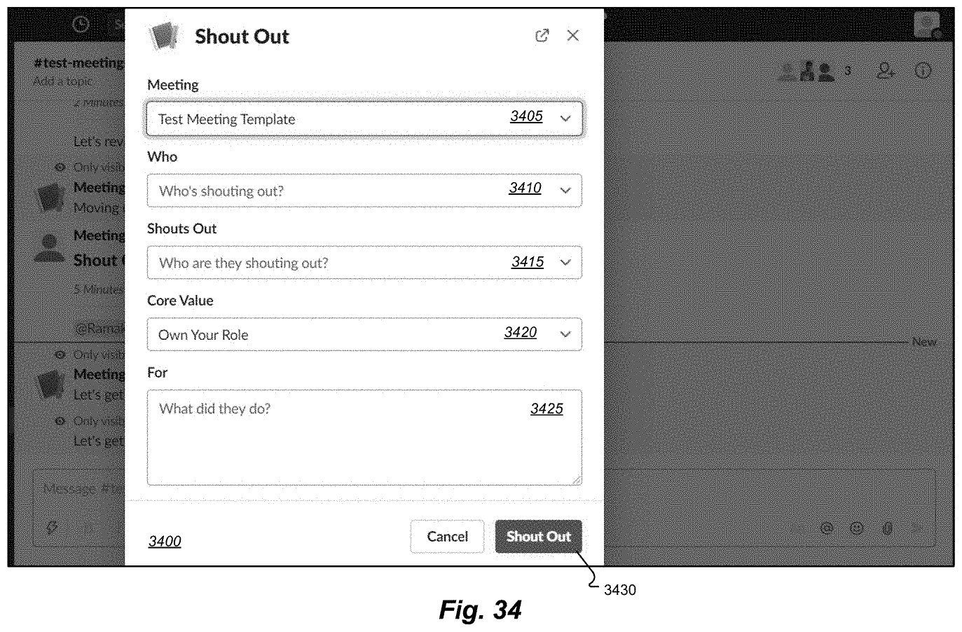

FIG. 34 is a screenshot illustrating an exemplary user interface for giving a shout out according to one embodiment of the present disclosure. As illustrated in this example, the interface can comprise a dialog box 3400, including a number of elements. In this example, the elements include a “Meeting” combo-box 3405 for selecting a meeting in which the shout out or will be noted, a “Who” combo-box 3410 for selecting a user giving the shout out, a “Shout Out” combo-box 3415 for selecting a user to receive the shout out, a “Core Value” combo-box 3420 for selecting value of the individual or organization forming the basis of the shout out, a “For” textbox 3425 for describing the reason for the shout out, and one or more buttons 3430 for cancelling the dialog or giving the shout out.

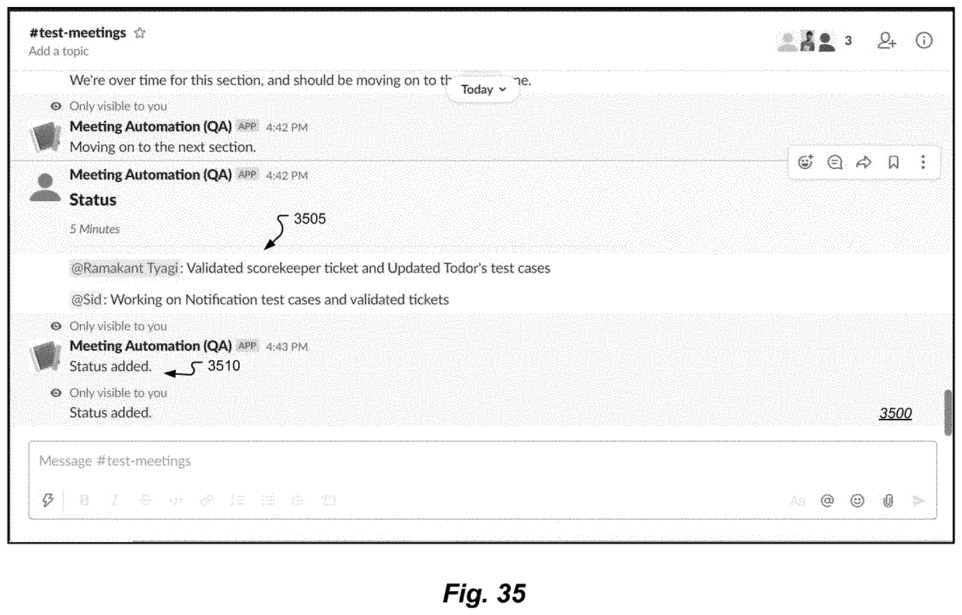

FIG. 35 is a screenshot illustrating an exemplary user interface for adding a status to a task according to one embodiment of the present disclosure. As illustrated in this example, the interface can comprise a dialog box 3500, including a number of elements. In this example, the elements include textual messages 3505 and 3510 indicating changes in status for one or more tasks in a meeting.

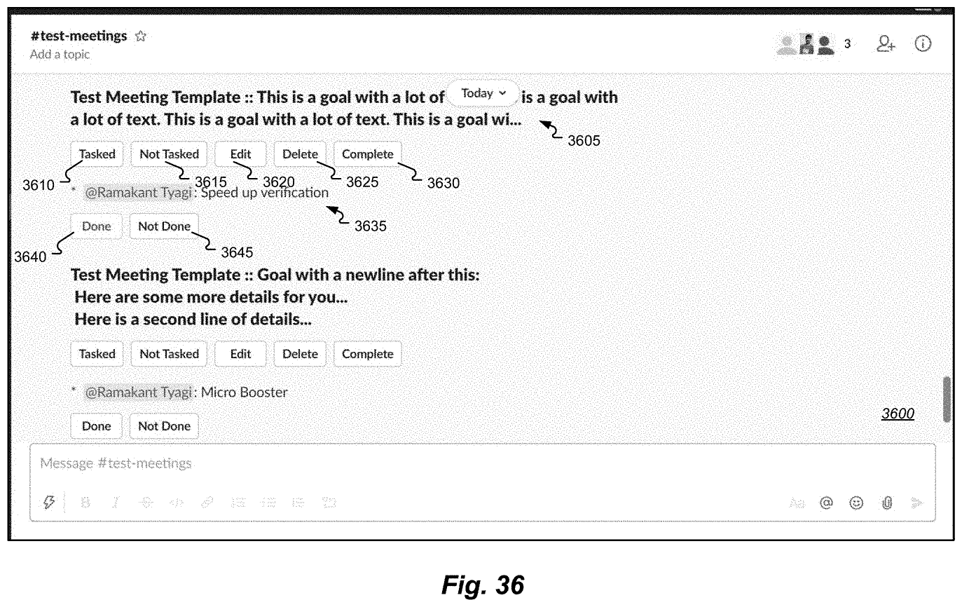

FIG. 36 is a screenshot illustrating an exemplary user interface for a task list with goals according to one embodiment of the present disclosure. As illustrated in this example, the interface can comprise a dialog box 3600, including a number of elements. In this example, the elements include a list of one or more tasks 3605. Each task 3605 of the list can be followed by a “Tasked” button 3610, a “Not Tasked” button 3615, an “Edit” button 3620, a “Delete” button 3625, and a “Complete” button 3630 any of which the user can click to modify the associated task. Each task can also be associated with one or more goals 1905. Each goal 3635 with each goal followed by a “Done” button 3640 and a “Not Done” button 3645 the user can click to indicate the current status of the associated goal.

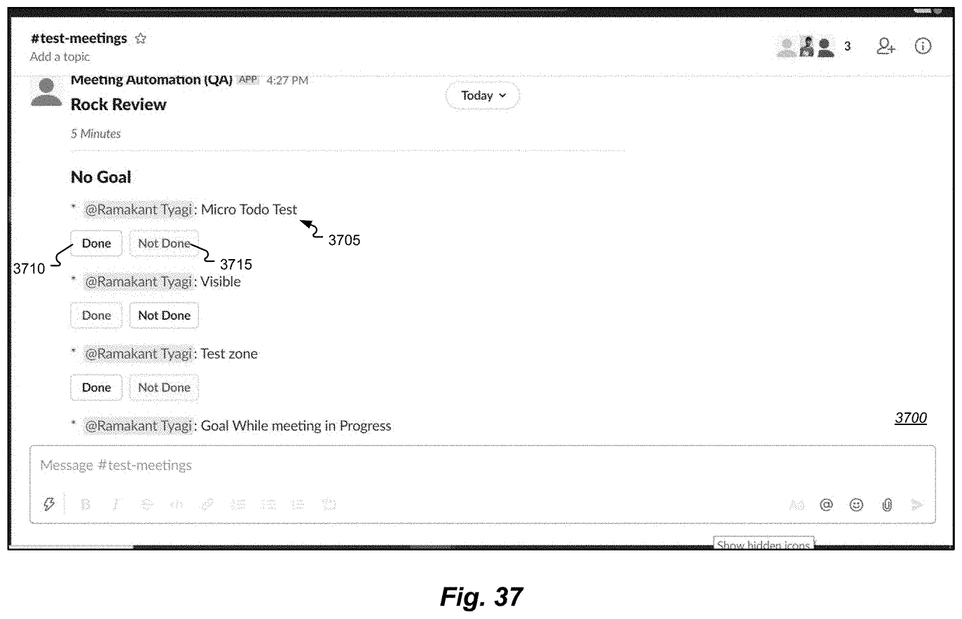

FIG. 37 is a screenshot illustrating an exemplary user interface for a task list without goals according to one embodiment of the present disclosure. As illustrated in this example, the interface can comprise a dialog box 3700, including a number of elements. In this example, the elements include a list of one or more tasks 3705. Each task 3705 of the list can be followed by “Done” button 3710 and a “Not Done” button 3715 the user can click to indicate the current status of the associated task.

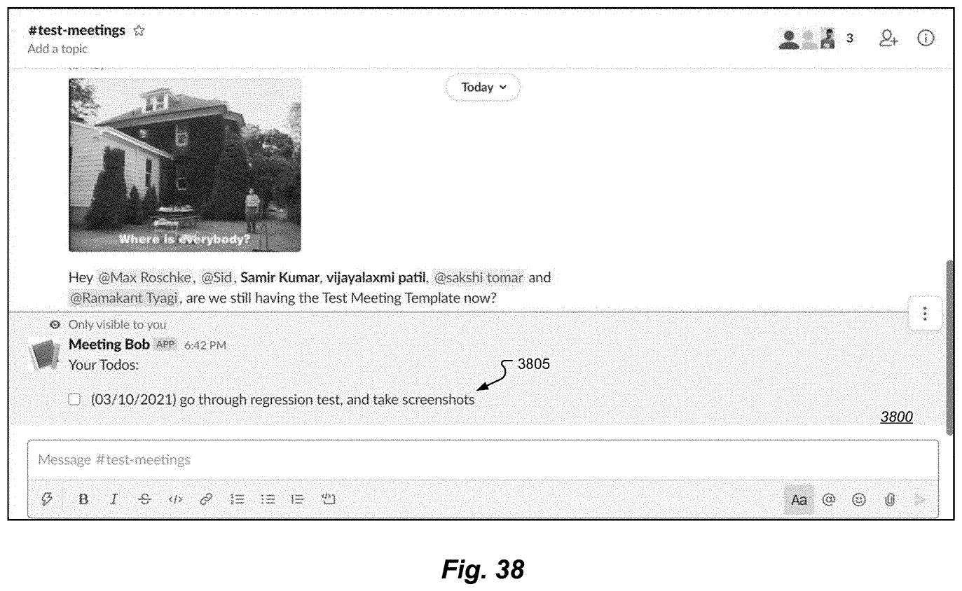

FIG. 38 is a screenshot illustrating an exemplary user interface for an individual's task list according to one embodiment of the present disclosure. As illustrated in this example, the interface can comprise a dialog box 3800, including a number of elements. In this example, the elements include a list of one or more tasks 3805 for the individual.

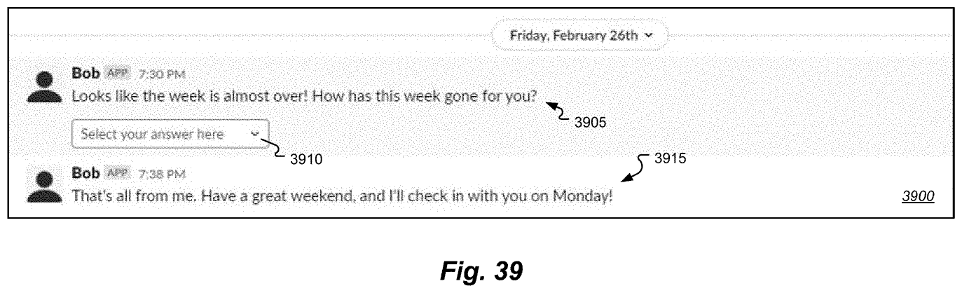

FIGS. 39-48 are screenshots illustrating exemplary user interfaces for conducting surveys according to one embodiment of the present disclosure. More specifically, FIG. 39 is a screenshot illustrating an exemplary user interface for an end of week survey according to one embodiment of the present disclosure. As illustrated in this example, the interface can comprise a dialog box 3900, including a number of elements. In this example, the elements include a question 3905 as may be generated by one or more bots 315 as described herein, a combo-box 3910 for selecting an answer to the question, and a reply 3915 to the selected answer. As described herein, the reply 3915 may also be generated by one or more bots 315.

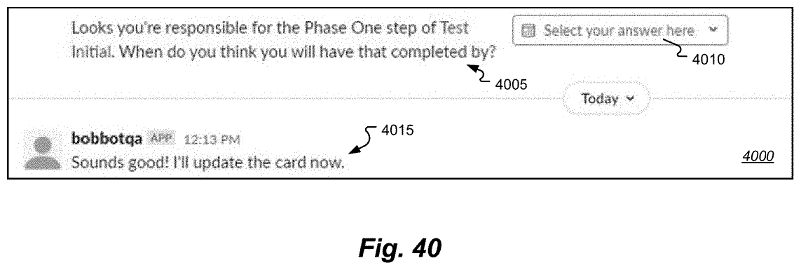

FIG. 40 is a screenshot illustrating an exemplary user interface for an initial due date survey according to one embodiment of the present disclosure. As illustrated in this example, the interface can comprise a dialog box 4000, including a number of elements. In this example, the elements include a question related to a due date for a task as may be generated by one or more bots 315 as described herein, a combo-box 4010 for selecting an answer to the question, and a reply 4015 to the selected answer. As described herein, the reply 4015 may also be generated by one or more bots 315.

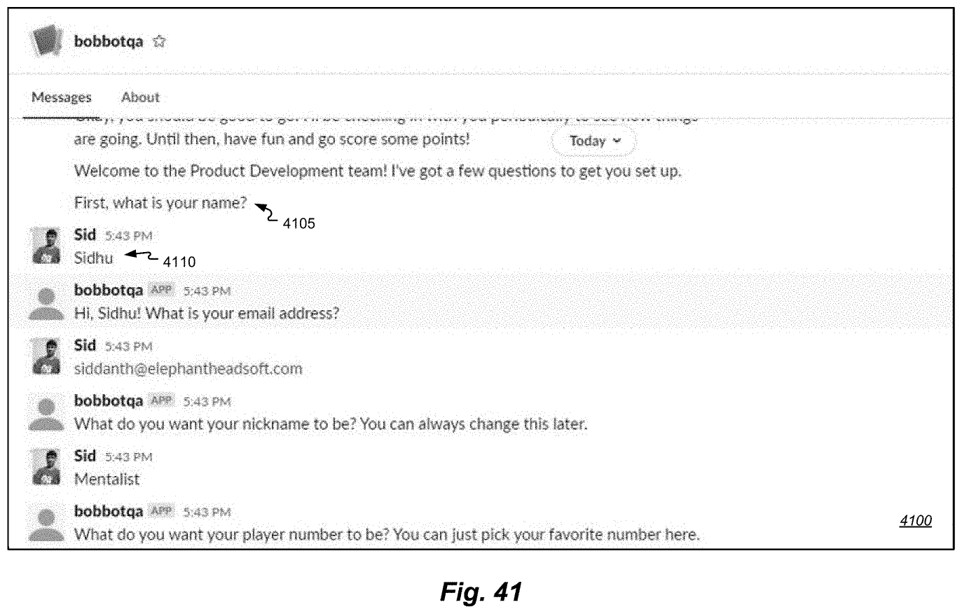

FIG. 41 is a screenshot illustrating an exemplary user interface for an onboarding survey according to one embodiment of the present disclosure. As illustrated in this example, the interface can comprise a dialog box 4100, including a number of elements. In this example, the elements include a number of lines of text representing a chat between one or more bots 315 as described herein and a user. This chat can include a question 4105 from the bot 315 followed by an answer 4110 from the user.

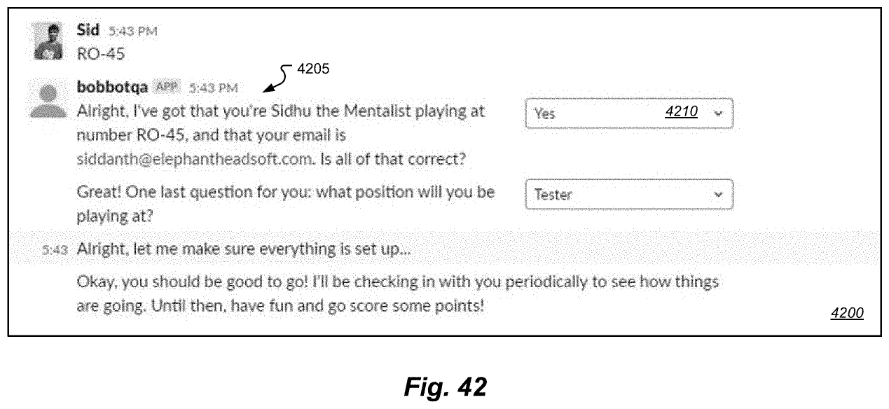

FIG. 42 is a screenshot illustrating additional details of an exemplary user interface for an onboarding survey according to one embodiment of the present disclosure. As illustrated in this example, the interface can comprise a dialog box 4200, including a number of elements. In this example, the elements include one or more questions 4205 as may be generated by one or more bots 315 as described herein and a combo-box 4210 associated with each question 4205 for selecting an answer to the question.

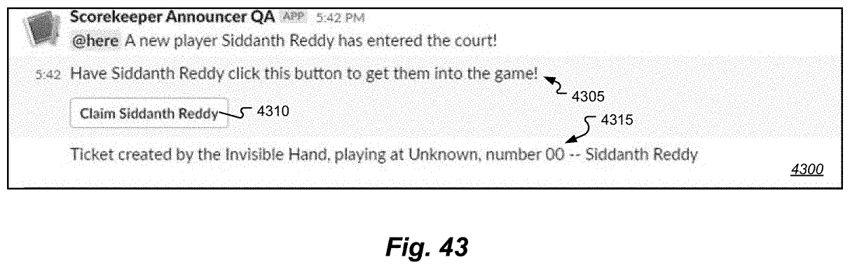

FIG. 43 is a screenshot illustrating an exemplary user interface for introducing an onboarded individual according to one embodiment of the present disclosure. As illustrated in this example, the interface can comprise a dialog box 4300, including a number of elements. In this example, the elements include a statement or announcement 4305 of availability of the new individual. The announcement may be generated by one or more bots 315 as described herein. The announcement can be followed by a button 4310 to add that person to a team. Once the new person has been added to the team, an acknowledgement message 4315 can be provided. As described herein, the acknowledgement 4315 may also be generated by one or more bots 315.

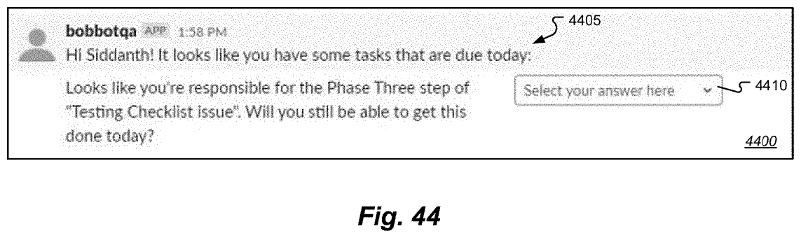

FIG. 44 is a screenshot illustrating an exemplary user interface for a test due date survey according to one embodiment of the present disclosure. As illustrated in this example, the interface can comprise a dialog box 4400, including a number of elements. In this example, the elements include a question 4405 regarding a due date as may be generated by one or more bots 315 as described herein and a combo-box 4410 for selecting an answer to the question.

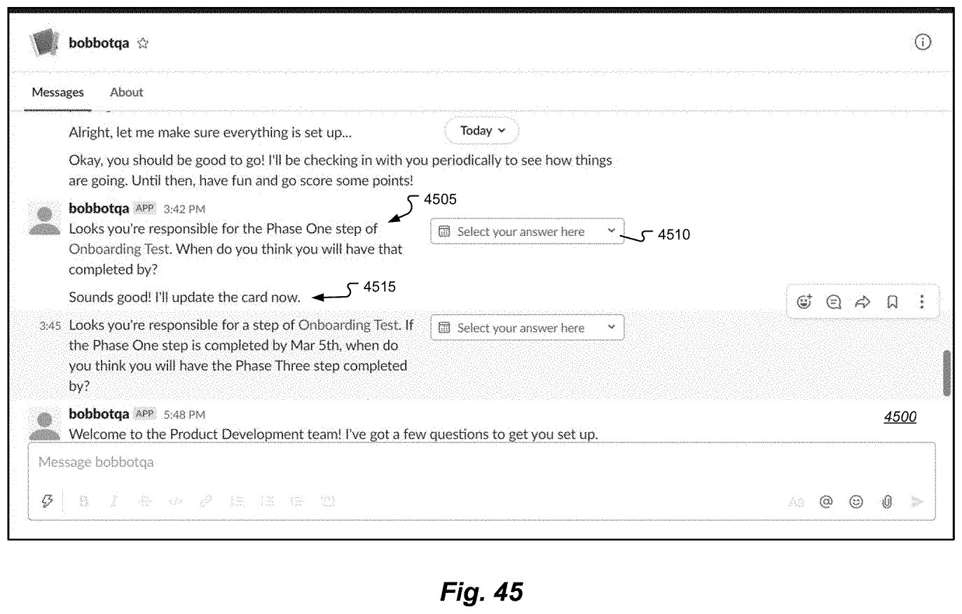

FIG. 45 is a screenshot illustrating an exemplary user interface for updating a due date according to one embodiment of the present disclosure. As illustrated in this example, the interface can comprise a dialog box 4500, including a number of elements. In this example, the elements include a question 4505 regarding a due date for a task as may be generated by one or more bots 315 as described herein, a combo-box 4510 for selecting an answer to the question, and a reply 4515 or to or acknowledgement of the selected answer. As described herein, the reply 3915 may also be generated by one or more bots 315.

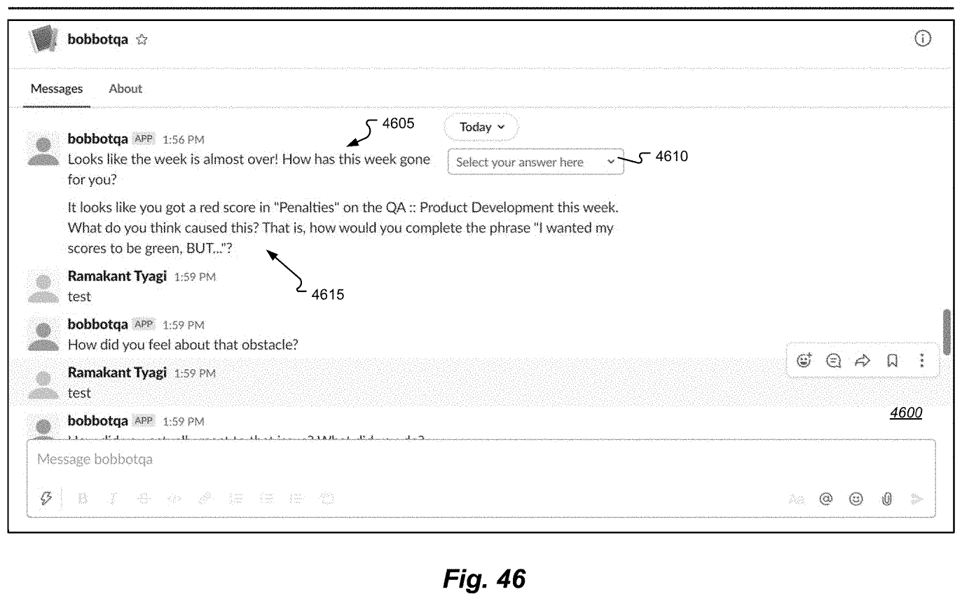

FIG. 46 is a screenshot illustrating an exemplary user interface for a weekly survey according to one embodiment of the present disclosure. As illustrated in this example, the interface can comprise a dialog box 4600, including a number of elements. In this example, the elements include a question 4605 about the week in review as may be generated by one or more bots 315 as described herein, a combo-box 4610 for selecting an answer to the question, and a reply 4615 to the selected answer. As described herein, the reply 4615 may also be generated by one or more bots 315.

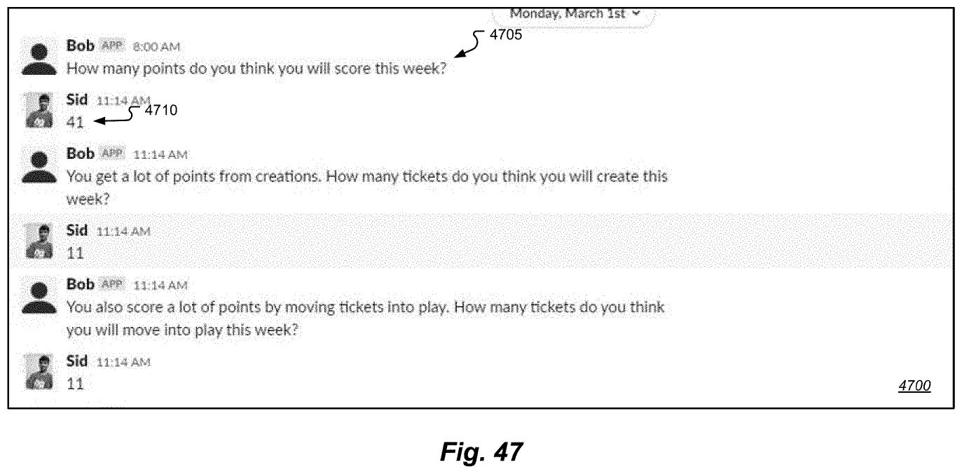

FIG. 47 is a screenshot illustrating an exemplary user interface for a weekly survey according to another embodiment of the present disclosure. As illustrated in this example, the interface can comprise a dialog box 4700, including a number of elements. In this example, the elements include a number of lines of text representing a chat between one or more bots 315 as described herein and a user. This chat can include a question 4705 about a week in review from the bot 315 followed by an answer 4710 from the user.

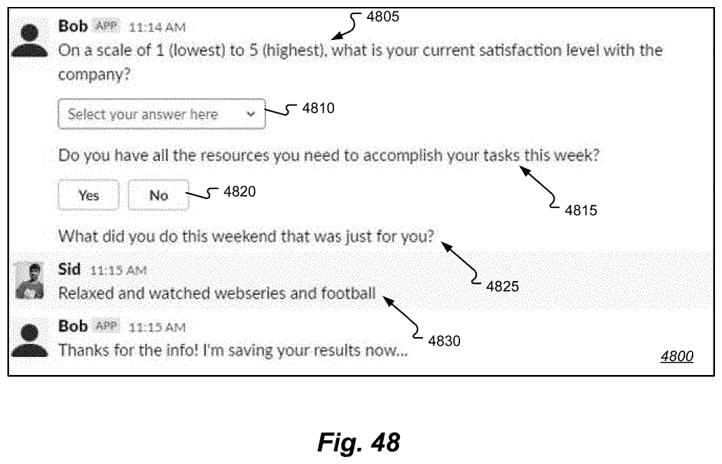

FIG. 48 is a screenshot illustrating additional details of an exemplary user interface for a weekly survey according to one embodiment of the present disclosure. As illustrated in this example, the interface can comprise a dialog box 4700, including a number of elements. In this example, the elements include a number of questions 4805 and 4815 about a week in review as may be generated by one or more bots 315 as described herein. Each question 4805 and 4815 can be followed by elements also generated by the bot 315 for answering the question. For example, question 4805 can be followed by combo-box 4810 for selecting one of a set of possible answers while question 4815 can be followed by buttons 4820 for selecting an answer. The dialog can also include lines of texts representing a question 4825 from the bot followed by a typed answer 4830 from the user and together representing a chat between the bot and the user.

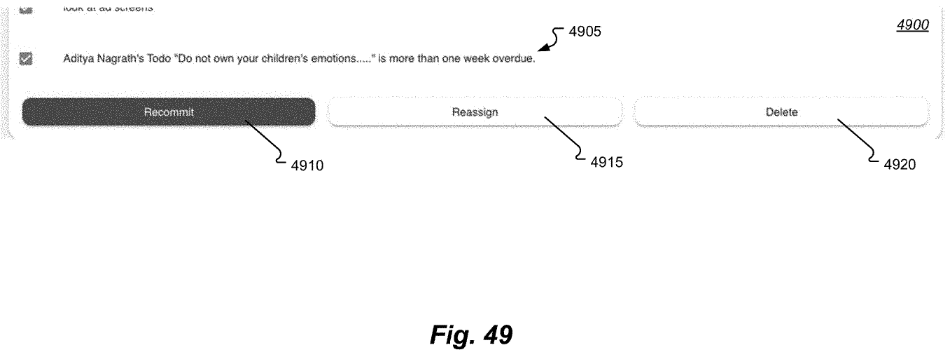

FIGS. 49 are screenshots illustrating exemplary user interfaces for updating a To Do item during a meeting according to one embodiment of the present disclosure. As illustrated in these examples, the interface can comprise a dialog box 4900, including a number of elements. In this example, the elements include text 4905 indicating a To Do item or task discussed during a meeting and which can be identified by a bot 315. Three resolution options can be automatically presented for that To Do item or task. The resolution options can be represented by a “Recommit” button 4910, a “Reassign” button 4915 to modify the To Do item or task, and a “Delete” button 4920 to remove the task. The user's resolution selection can be tracked and displayed. As illustrated in FIG. 49, users can select “Recommit” to maintain the task, perhaps with a new due date.

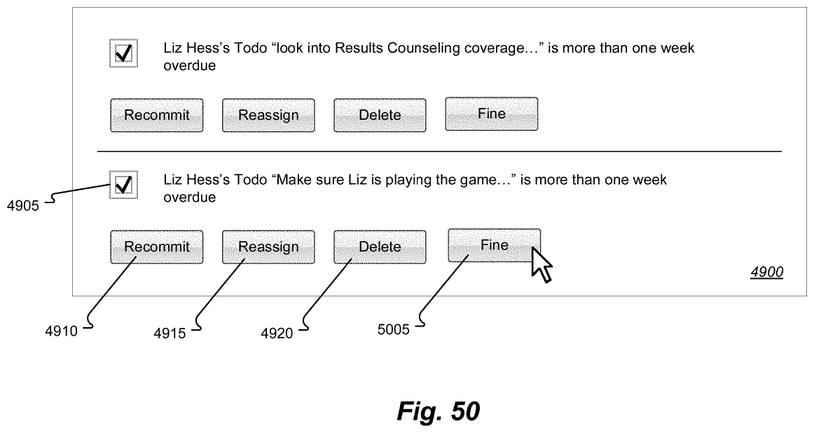

On the other hand, and as illustrated in FIG. 50, users can select “Delete” to remove a task that has not been completed. Thus, when a task or to do item is overdue, there are only three options, recommit, reassign, or delete. Those can be presented front and center on the meeting so that no one thinks that there is another option, e.g., ignoring the task, and healthy options for handling the task are listed, i.e., the person can either recommit to doing it, it can be reassigned to someone else, or a decision can be made to not do it. As also illustrated in FIG. 50, a “Fine” button or other element may additionally, or alternatively, be presented. As will be described below with reference to FIG. 51, a fine process may be implemented to fine or adjust downward a score for a user in case a task is late, incomplete, improperly performed, etc. Such a fine may be applied in addition to another action, such a reassigning the task or may be applied individually without another action.

FIG. 51 is a flowchart illustrating an exemplary process for updating one or more tasks during a meeting according to one embodiment of the present disclosure. As illustrated in this example, managing a meeting between the plurality of users in the gamification system, such as described above, can comprise maintaining 5105 a meeting agenda defining topics for a meeting and a schedule for the meeting. As described above, the meeting agenda includes as topics each of the one or more tasks. The meeting can be initiated 5110 with two or more users of the plurality of users in the gamification system through a messaging service at a time indicated in the schedule for the meeting and a status for the tasks identified in the agenda can be presented 5115, through the messaging service, based on the meeting agenda, such as in the examples described above with reference to FIGS. 49 and 50. An indication of an update for each of the one or more tasks can be received 5120 through the messaging service, i.e., based on a selection of an action to be taken as described above and the status or the business process definition for each of the one or more tasks can be updated based on the received indication of the update for each of the one or more tasks.

More specifically, a determination 5125 can be made as to whether the indication of the update for at least one of the one or more tasks comprises an indication for the user assigned to the at least one task to recommit to completing the task. In response to determining 5125 the indication of the update for at least one of the one or more tasks comprises an indication for the user assigned to the at least one task to recommit to completing the task, the status of the at least one task can be updated 5130 to indicate the user assigned to the at least one task recommit recommitting to the at least one task.

In response to determining 5125 the indication of the update for at least one of the one or more tasks does not comprise an indication for the user assigned to the at least one task to recommit to completing the task, a further determination 5135 can be made as to whether the indication of the update for at least one of the one or more tasks comprises an indication to reassign the task. In response to determining 5135 that the indication of the update for at least one of the one or more tasks comprises an indication to reassign the task, a new user of the plurality of users can be assigned 5140 to the at least one task in the business definitions.

In response to determining 5135 that the indication of the update for at least one of the one or more tasks does not comprise an indication to reassign the task, a further determination 5145 can be made as to whether the indication of the update for at least one of the one or more tasks comprises an indication to delete the task. In response to determining 5145 the indication of the update for at least one of the one or more tasks comprises an indication to delete the task, the business process definitions can be updated 5150 to remove the at least one task.

Regardless of previous determinations 5125, 5135, and/or 5145, a further determination 5155 can be made as to whether the indication of the update for the at least one of the one or more tasks comprises an indication to fine the user assigned to the at least one task. That is, a fine can be applied instead of or in addition to other actions taken to the task. In response to determining 5155 the indication of the update for the at least one of the one or more tasks comprises an indication to fine the user assigned to the at least one task, the user assigned to the task can be fined by updating a score of the user assigned to the task, e.g., deducting a predetermined amount from the user's score thereby possibly affecting a bonus or other reward for that user. The amount of the fine can be determined based on a fixed amount, based on an amount for a level or importance for the task, based on an amount of time the task is overdue, etc.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for managing business processes, the method comprising:
reading, by a gamification system, a set of business process definitions and statuses from a project management system, wherein the business process definitions define a plurality of tasks, each task of the plurality of tasks assigned to a user of a plurality of users in the gamification system, the plurality of tasks defining a workflow, and wherein the statuses indicate a current state of one or more tasks of the plurality of tasks;
maintaining, by the gamification system, a set of transition rules defining processes for transitioning items through the workflow defined in the business process definitions;
managing, by the gamification system, scoring of each user of the plurality of users in the gamification system based on the business process definitions and statuses and the set of transition rules; and
managing, by the gamification system, a meeting between the plurality of users in the gamification system based on the business process definitions and statuses and the set of transition rules, wherein managing the meeting comprises updating the status or the business process definition for one or more tasks of the plurality of tasks.

2. The method of claim 1, wherein managing the meeting between the plurality of users in the gamification system further comprises:
maintaining a meeting agenda defining topics for a meeting and a schedule for the meeting, wherein the meeting agenda includes as topics each of the one or more tasks;
initiating the meeting with two or more users of the plurality of users in the gamification system through a messaging service at a time indicated in the schedule for the meeting;
presenting, through the messaging service, based on the meeting agenda, a description and the status of each of the one or more tasks;
receiving, through the messaging service, an indication of an update for each of the one or more tasks; and
updating the status or the business process definition for each of the one or more tasks based on the received indication of the update for each of the one or more tasks.

3. The method of claim 2, wherein the indication of the update for at least one of the one or more tasks comprises an indication for the user assigned to the at least one task to recommit to completing the task and wherein updating the status of the at least one task comprises updating the status to indicate the user assigned to the at least one task recommit recommitting to the at least one task.

4. The method of claim 2, wherein the indication of the update for at least one of the one or more tasks comprises an indication to reassign the task and wherein the updating the status or the business process definition for at least one task comprises assigning a new user of the plurality of users to the at least one task.

5. The method of claim 2, wherein the indication of the update for at least one of the one or more tasks comprises an indication to delete the task and wherein the updating the status or the business process definition for the at least one task comprises updating the business process definitions to remove the at least one task.

6. The method of claim 2, wherein the indication of the update for the at least one of the one or more tasks comprises an indication to fine the user assigned to the at least one task.

7. The method of claim 6, wherein fining the user assigned to the at least one task comprises updating a score of the user assigned to the task.

8. A system comprising:
a communications network;
a project management system communicatively coupled with the communications network, the project management system maintaining a set of business process definitions and statuses, wherein the business process definitions define a plurality of tasks, each task of the plurality of tasks to be performed by one of more users of a plurality of users in the gamification system, the plurality of tasks defining a workflow, and wherein the statuses indicate a current state of one or more tasks of the plurality of tasks; and
a gamification system communicatively coupled with the communications network, the gamification system comprising a processor and a memory coupled with and readable by the processor and storing therein a set of instructions which, when executed by the processor, causes the processor to manage the business processes by:
reading a set of business process definitions and statuses from a project management system, wherein the business process definitions define a plurality of tasks, each task of the plurality of tasks assigned to a user of a plurality of users in the gamification system, the plurality of tasks defining a workflow, and wherein the statuses indicate a current state of one or more tasks of the plurality of tasks;
maintaining a set of transition rules defining processes for transitioning items through the workflow defined in the business process definitions;
managing scoring of each user of the plurality of users in the gamification system based on the business process definitions and statuses and the set of transition rules; and
managing a meeting between the plurality of users in the gamification system based on the business process definitions and statuses and the set of transition rules, wherein managing the meeting comprises updating the status or the business process definition for one or more tasks of the plurality of tasks.

9. The system of claim 8, wherein managing the meeting between the plurality of users in the gamification system further comprises:
maintaining a meeting agenda defining topics for a meeting and a schedule for the meeting, wherein the meeting agenda includes as topics each of the one or more tasks;
initiating the meeting with two or more users of the plurality of users in the gamification system through a messaging service at a time indicated in the schedule for the meeting;
presenting, through the messaging service, based on the meeting agenda, a description and the status of each of the one or more tasks;
receiving, through the messaging service, an indication of an update for each of the one or more tasks; and
updating the status or the business process definition for each of the one or more tasks based on the received indication of the update for each of the one or more tasks.

10. The system of claim 9, wherein the indication of the update for at least one of the one or more tasks comprises an indication for the user assigned to the at least one task to recommit to completing the task and wherein updating the status of the at least one task comprises updating the status to indicate the user assigned to the at least one task recommit recommitting to the at least one task.

11. The system of claim 9, wherein the indication of the update for at least one of the one or more tasks comprises an indication to reassign the task and wherein the updating the status or the business process definition for at least one task comprises assigning a new user of the plurality of users to the at least one task.

12. The system of claim 9, wherein the indication of the update for at least one of the one or more tasks comprises an indication to delete the task and wherein the updating the status or the business process definition for the at least one task comprises updating the business process definitions to remove the at least one task.

13. The system of claim 9, wherein the indication of the update for the at least one of the one or more tasks comprises an indication to fine the user assigned to the at least one task.

14. The system of claim 13, wherein fining the user assigned to the at least one task comprises updating a score of the user assigned to the task.

15. A non-transitory, computer-readable medium comprising a set of instructions stored therein which, when executed by a processor, causes the processor to manage business processes by:
reading a set of business process definitions and statuses from a project management system, wherein the business process definitions define a plurality of tasks, each task of the plurality of tasks assigned to a user of a plurality of users in the gamification system, the plurality of tasks defining a workflow, and wherein the statuses indicate a current state of one or more tasks of the plurality of tasks;
maintaining a set of transition rules defining processes for transitioning items through the workflow defined in the business process definitions;
managing scoring of each user of the plurality of users in the gamification system based on the business process definitions and statuses and the set of transition rules; and
managing a meeting between the plurality of users in the gamification system based on the business process definitions and statuses and the set of transition rules, wherein managing the meeting comprises updating the status or the business process definition for one or more tasks of the plurality of tasks.

16. The non-transitory, computer-readable medium of claim 15, wherein managing the meeting between the plurality of users in the gamification system further comprises:
maintaining a meeting agenda defining topics for a meeting and a schedule for the meeting, wherein the meeting agenda includes as topics each of the one or more tasks;
initiating the meeting with two or more users of the plurality of users in the gamification system through a messaging service at a time indicated in the schedule for the meeting;
presenting, through the messaging service, based on the meeting agenda, a description and the status of each of the one or more tasks;
receiving, through the messaging service, an indication of an update for each of the one or more tasks; and
updating the status or the business process definition for each of the one or more tasks based on the received indication of the update for each of the one or more tasks.

17. The non-transitory, computer-readable medium of claim 16, wherein the indication of the update for at least one of the one or more tasks comprises an indication for the user assigned to the at least one task to recommit to completing the task and wherein updating the status of the at least one task comprises updating the status to indicate the user assigned to the at least one task recommit recommitting to the at least one task.

18. The non-transitory, computer-readable medium of claim 16, wherein the indication of the update for at least one of the one or more tasks comprises an indication to reassign the task and wherein the updating the status or the business process definition for at least one task comprises assigning a new user of the plurality of users to the at least one task.

19. The non-transitory, computer-readable medium of claim 16, wherein the indication of the update for at least one of the one or more tasks comprises an indication to delete the task and wherein the updating the status or the business process definition for the at least one task comprises updating the business process definitions to remove the at least one task.

20. The non-transitory, computer-readable medium of claim 16, wherein the indication of the update for the at least one of the one or more tasks comprises an indication to fine the user assigned to the at least one task and wherein fining the user assigned to the at least one task comprises updating a score of the user assigned to the task.
